(19) United States
(12) Patent Application Publication
(10) Pub. No.: US 2021/0124745 A1
(43) Pub. Date: Apr. 29, 2021

(54) SEMANTIC SEARCH AND RULE METHODS FOR A DISTRIBUTED DATA SYSTEM

(71) Applicant: SCHNEIDER ELECTRIC USA, INC., Andover, MA (US)

(72) Inventors: Charbel Joseph El Kaed, Boston, MA (US); Andre van den Berg, Pretoria (ZA)

(21) Appl. No.: 16/497,922

(22) PCT Filed: Mar. 30, 2018
(86) PCT No.: PCT/US2018/025493

§ 371 Date: Sep. 26, 2019

Related U.S. Application Data
(60) Provisional application No. 62/479,120, filed on Mar. 30, 2017.

(51) Int. Cl. G06F 16/2455

(52) U.S. Cl. CPC G06F 16/24564; H04L 67/125

(57) ABSTRACT

Systems and methods for a hybrid connected device actuation system are provided. A method for use with a hybrid connected device actuation system may comprise, processing a hybrid actuation query that may include semantic query and rules data, determining at least one actuatable connected device associated with a control system based on the processed hybrid actuation query data and an ontological data associated with the control system, determining an actuatable variable associated with the at least one determined connected device based on the rules data associated with the hybrid actuation query, and executing a change in an operational state of the actuatable variable associated with the at least one determined connected device in the control system.

### FIELD OF THE INVENTION

Embodiments of the present disclosure relate generally to methods of data processing, and more specifically to systems and methods for querying and associating operational rules for data associated with a distributed data processing system.

### PRIORITY CLAIM

This application claims priority to and benefit from the following provisional patent application: U.S. Provisional Application Ser. No. U.S. 62/479,120 titled “Semantic Search and Rule Methods for a Distributed Data System” filed on Mar. 30, 2017. The entire contents of this aforementioned patent application are expressly incorporated by reference herein.

### BACKGROUND

### Description of the Related Art

The Internet of Things (IoT) promises to interconnect elements together on a massive scale. Such amalgamation allows interactions and collaborations between these elements in order to fulfill one or more specific tasks. Such tasks differ according to the context and environment of application. For example, tasks may range from sensing and monitoring of an environmental characteristic such as temperature or humidity of a single room to controlling and optimization of an entire building or facility in order to achieve a larger objective such as an energy management strategy.

Depending on the application, connected elements, devices, and/or components may be of heterogeneous and/or homogenous hardware which may facilitate sensing, actuation, data capture, data storage, or data processing. Each type of connected element hardware may have a unique data structure which details a digital representation of the physical capabilities of the hardware itself and/or measured parameters. For example, a temperature sensor may include temperature measurement, MAC address, IP address, and CPU type data. Each connected hardware element may possess a unique data structure. Accordingly, with the heterogeneity of these various data structures available through the wide variety of available hardware, efficiently analyzing and controlling this data becomes a serious challenge.

### SUMMARY

Systems and methods for a Hybrid Connected Device Actuation System (herein referred to as HCDAS) are provided. A system for a hybrid connected device actuation system may comprise, at least one processor configured to process a hybrid actuation query that may include semantic query and operational rules data, determine at least one actuatable connected device associated with a control system based on the processed hybrid actuation query data and an ontological data associated with the control system, determine an actuatable variable associated with the at least one determined connected device based on the operational rules data associated with the hybrid actuation query, and execute a change in an operational state of the actuatable variable associated with the at least one determined connected device in the control system.

Principles of the disclosure contemplate that the at least one processor may be further configured to determine actuatable operational states associated with the determined at least one connected device by applying the ontological query component to an actuatable rules engine control module.

In additional embodiments the at least one processor may be configured to determine available rule actuatable variables associated with the at least one connected devices identified by correlating appropriate hierarchical control structures in an ontological library with rule actuatable connected devices associated with the control system.

In further embodiments the processor may be configured to determine at least one connected device associated with a control system by correlating the appropriate hierarchical control structures in an ontological library with rule actuatable connected devices associated with the control system.

Principals of the disclosure further contemplate the rules data has an associated lifecycle. Further principles contemplate the rules data has an associated conflict mechanism and the rules data has an associated conditional mechanism.

Systems and methods for an ontological based query and rule execution system are provided. A system for an ontological based query and rule execution system may comprise, at least one processor configured to receive a structured search query having query elements and a rule data set, identify a set of connected elements based on the query elements, annotate a data structure of each of the identified set of connected elements to form a queried data set, provide the queried data set to a rule engine, evaluate conditions related to the set of connected elements and the rule data set, determine a command set based on the evaluated conditions of the set of connected elements, and execute the command set on the set of connected elements.

In one aspect a hybrid connected device actuation execution method is provided. The method includes processing a hybrid actuation query that includes semantic query and rules data, determining at least one actuatable connected device associated with a control system based on the processed hybrid actuation query data and an ontological data associated with the control system, determining an actuatable variable associated with the at least one determined connected device based on the rules data associated with the hybrid actuation query, and executing a change in an operational state of the actuatable variable associated with the at least one determined connected device in the control system.

### BRIEF DESCRIPTION OF THE DRAWINGS

These accompanying drawings are not intended to be drawn to scale. In the drawings, each identical or nearly identical component that is illustrated in various figures is represented by a line numeral. For purposes of clarity, not every component may be labeled in every drawing. In the drawings:

FIG. 1 illustrates aspects of a system for facilitating a HCDAS in accordance with various embodiments of this disclosure;

FIG. 2 illustrates various embodiments of how different types of devices may connect to a HCDAS in accordance with various embodiments of this disclosure;

FIG. 3A illustrates an exemplary deployment of various connected elements of a HCDAS in accordance with various embodiments of this disclosure;

FIG. 3B illustrates exemplary deployment of connected elements across a variety of physical locations of a HCDAS from FIG. 3A;

FIG. 3C illustrates exemplary hierarchical data organization constructs within a user interface of connected elements across a HCDAS;

FIG. 3D illustrates exemplary ontological data organization constructs of connected elements across a HCDAS;

FIG. 3E illustrates exemplary control systems utilizing an ontological data construct and connected elements across a HCDAS;

FIG. 4A is a block diagram of components and interconnections of a HCDAS;

FIG. 4B is a block diagram of various embodiments of components and interconnections of a HCDAS controller;

FIG. 4C is a block diagram of an embodiment of components of the system for a HCDAS;

FIG. 4D is a block diagram of an embodiment of components of the system for a HCDAS including detail of a semantic engine;

FIG. 4E is a block diagram of an embodiment of components of the system for a HCDAS including detail of a rule engine;

FIG. 5 is a block diagram of an embodiment of components of the system for a HCDAS including detail of a semantic engine and a rule engine;

FIG. 6A is a flow diagram for executing a HCDAS;

FIG. 6B is a flow diagram of exemplary command functions for a HCDAS;

FIG. 6C is a flow diagram of exemplary command functions for a HCDAS from FIG. 6B;

FIG. 6D illustrates a flow diagram of an embodiment of operational rule lifecycle operations for an HCDAS from FIG. 6C;

FIG. 7 illustrates a flow diagram of an embodiment of operational rule conditionality operations for an HCDAS;

FIG. 8 illustrates extensible alternate embodiments of a HCDAS;

FIGS. 9A to 9N illustrates various exemplary embodiments of LUA implementation details of a HCDAS;

FIG. 10 is a functional block diagram of a general-purpose computer system in accordance with embodiments of this disclosure; and

FIG. 11 is a functional block diagram of a general-purpose storage system in accordance with the general-purpose computer system of FIG. 10.

### DETAILED DESCRIPTION

This disclosure is not limited in its application to the details of construction and the arrangement of components set forth in the following descriptions or illustrated by the drawings. The disclosure is capable of other embodiments and of being practiced or of being carried out in various ways. Also, the phraseology and terminology used herein is for the purpose of descriptions and should not be regarded as limiting. The use of “including,” “comprising,” “having,” “containing,” “involving,” and variations herein, are meant to be open-ended, i.e. “including but not limited to.”

In the emerging world of the Internet of Things (IoT) or more generally, Cyber Physical Systems (CPS), a convergence of multiple technologies is underway to allow the sensing, actuation, data capture, storage, or processing from a large array of connected elements, devices, and/or components be them physical, virtual, and/or a hybrid combination of the two. These connected elements may be accessed remotely using existing network infrastructure to allow for efficient Machine to Machine (M2M) and Human to Machine (H2M) communication. During this communication, as the network of connected elements changes over time, an increasing amount of data from these connected elements will be generated and allow for correlations which have not been possible before. Issues of organizing dynamic sets of connected elements are exacerbated by the disparate heterogeneous nature of the associated data structures.

With this plethora of hardware and associated data structures, a problem of organizing and analysis of data emerges as a wide variety of data structures may be received at a single processing point from the vast network of connected elements. A need exists for the ability to process, request, and analyze data from heterogeneous sources from the connected elements. Each individual connected element may contain multiple data characteristics from a data structure that are similar to other individual or group of elements. Yet, even with these similar data characteristics, efficiently querying and affecting changes on these similar data characteristics and associated devices across the plethora of different connected elements is a significant challenge. One method to solve this problem of data heterogeneity involves the implementation and execution of a hybrid system to query, define operational rules, and operate connected elements utilizing semantic constructs.

A solution to the data challenge is the use of a hybrid structured semantic and operational rules queries solves two distinct problems. First, is to solve the issue of data heterogeneity delivered from a connected system which contains various data structures. Second is to filter and aggregate this heterogeneous data from the connected elements and provide only required and relevant data to a user, cloud platform, or other repository. Third, to control and interact with the environment, devices, equipment, or/and systems.

Energy consuming devices evolved from having only the option of being switched on or off, to allowing more control and capabilities to better attain a desired goal. For example, the motion activated light switches and climate control air conditioning systems found in most modern buildings. These devices however have mainly worked in isolation taking only into account measurements of the device itself.

The “smart devices” used today are much more intelligent than their predecessors. These devices have the capability to interact and communicate with each other using protocols such as TCP/IP, GPRS, 3G, Zigbee, etc. Many of these devices have the capability to be connected to an intranet network. This further improves the interaction possible with these devices and allows for example the storage of measurements received from devices on a normal database.

A key advantage of being able to gather data from multiple devices is that this data can be analyzed and used to improve the overall performance of a system. To implement these improvements, it is necessary to specify operational rules and redeploy these operational rules to the different devices. These operational rules can range from something as simple as sending an alarm to a monitoring platform when the temperature in a room reaches a certain threshold, to a more complex operational rule controlling the air flow rate within an underground mine.

The challenge lies in timely control of devices and sending of relevant information for monitoring purposes. All of this has to happen within a very dynamic environment that interacts with a multitude of devices controlling different environmental variables and using different protocols for communication.

Example applications of implementation and execution may include, but are not limited to: (1) managing HVAC systems to assure the comfort of facility occupants, (2) maintenance of a particular environmental air quality (which may consist of temperature, humidity, and carbon dioxide content) for storage or occupants and dynamically adjusting a working building environment according to the prevailing weather conditions, (3) manage a facility management through controlling and optimizing regarding energy consumption through active control of lighting, heating, and cooling, and (4) monitor day to day operations, maintenance, and oversight of facility operations. Commercial embodiments of such applications may be a part of building management or automation system.

It is to be understood that the system described herein facilitates significant flexibility in terms of configuration and/or end user application and that although several examples are described a number of alternative embodiment configurations and applications are also possible.

Generally, such tasks are performed by individuals who are relatively non-technical in nature and require a rich interactive experience which hides the complexity of the data heterogeneity problem. Advantages of the various embodiments contained herein include; allowing for the search of specific connected elements or associated data structures; configuring of alerts and notification messages adhering to a facility specific architecture without intimate knowledge of same; allowing for execution of facility specific queries to determine real-time metrics such as energy consumption by area; and configuring any type of data structure to collect in a manner that does not require translation of units or other specific constructs.

It should be appreciated that a hybrid approach is necessary which consists of at least semantic queries and execution of semantic operational rules in a tightly bound system to obtain many of the benefits described herein. As such, systems and methods for a Hybrid Connected Device Actuation System (herein referred to as HCDAS) are discussed.

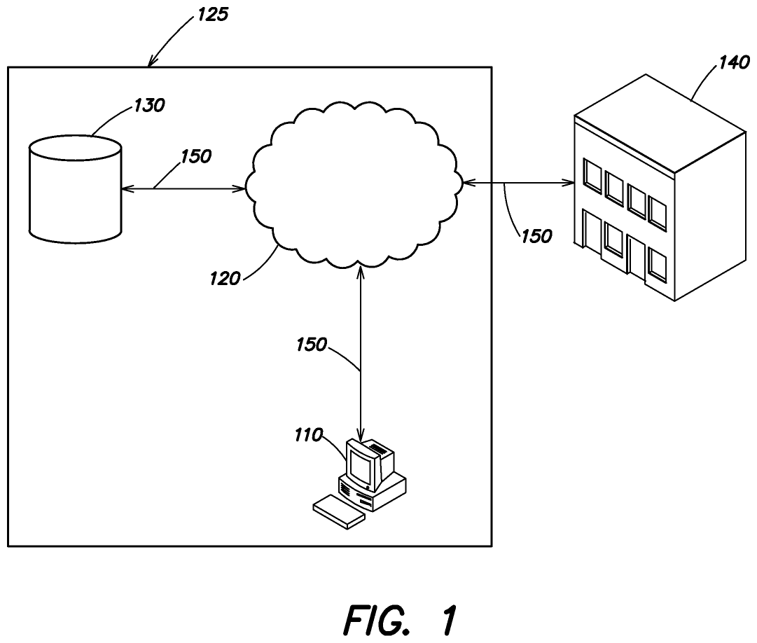

FIG. 1 illustrates aspects of a system for facilitating a HCDAS in accordance with various embodiments of this disclosure may be implemented. The system utilizing a HCDAS 125 may include one or more general purpose computers 110, one or more data storage arrays 130, a cloud computing environment 120, a building or other structure 140 which contains one or more connected elements (not shown), and network connections 150 to allow the exchange of data between these parts of the system.

In one embodiment of the system illustrated in FIG. 1, the building 140 contains one or more connected elements, components, devices, and/or drive components which are physical, virtual, or a hybrid of the two, that perform sensing, actuation, data capture, storage, or processing for the monitoring or control or management of the building 140. Any variety of connected elements may be used to capture, store, or process data, or actuate associated devices over the network connections 150, to the cloud computing environment 120, to other parts of the system. These connected elements may, for example, detect temperature, humidity, ambient light, sound, smoke, carbon monoxide, carbon dioxide, motion, non-conductive fluids, conductive fluids, vibration, energy, power, voltage, current, or any other desired characteristic, and combination thereof. Connected elements may also operate or articulate elements, components, and/or other systems such as turning on lights, opening a door or window, moving window shades, or triggering a door lock. Connected elements may also process data structures from other connected elements or propagate data structures from one or more connected elements to one or more other connected elements. Any number of connected elements may be deployed in any combination to monitor or manage a physical space. Examples of such a space may include a closet, room, building, campus, office, promenade, or any other desired location.

Each building 140 containing a connected element may ultimately connect to a cloud-computing environment 120 through a network connection 150. This connection allows access to the cloud computing environment 120 by a variety of devices capable of connecting to such an environment in either a wired or wireless connection manner. From FIG. 1 such devices may include one or more general-purpose computers 110 capable of receiving input from a user or to provide autonomous operation. One or more data storage arrays 130 may be utilized to provide additional data storage capability. It should be appreciated a cloud computing environment 120, while providing additional communication paths to additional elements or systems, is not required as part of the semantic search method. Other embodiments contemplate self-contained or stand-alone systems.

The network connections 150 may be wired or wireless connection types. Such connections may include, but are not limited to, any physical cabling method such as category 5 cable, coaxial, fiber, copper, twisted pair, or any other physical media to propagate electrical signals. Wireless connections may include, but are not limited to personal area networks (PAN), local area networks (LAN), Wi-Fi, Bluetooth, cellular, global, or space based communication networks. Access between the cloud environment 120 and any other cloud environment is possible in other implementations these other cloud environments are configured to connect with devices similar to cloud environments such as the existing cloud environment 120. It is to be understood that the computing devices shown in FIG. 1 are intended to be illustrative only and that computing nodes and cloud computing environments may communicate with any type of computerized device over any type of network with addressable or direct connections.

Principles of the disclosure include a HCDAS 125 may contain the elements details in FIG. 1, may include additional or fewer of these elements, or may be located in a building 140, a series of buildings. A HCDAS 125 may be physical, may be virtual, or a hybrid combination of both. No limitations are implied as to the composition, location, or organization of the HCDAS 125.

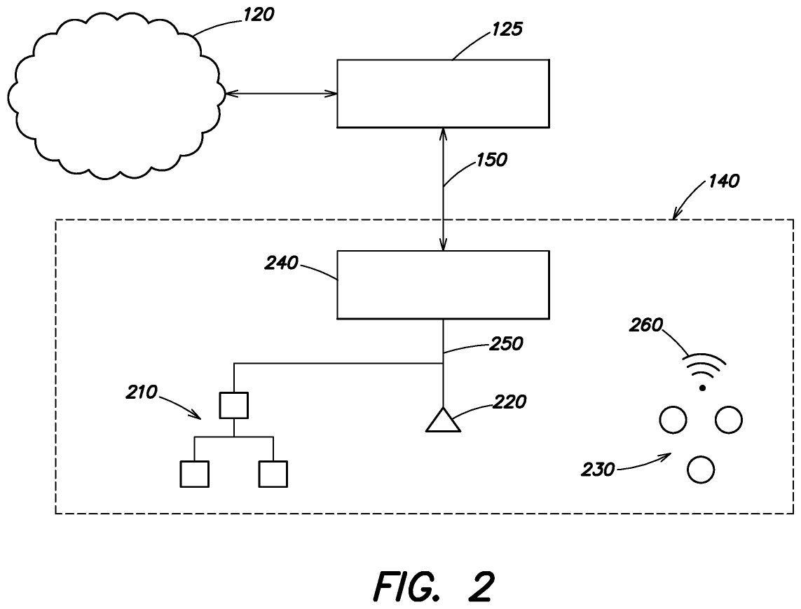

FIG. 2 illustrates various embodiments of how different types of devices may connect to a HCDAS in accordance with various embodiments of this disclosure. In one embodiment of FIG. 2, the building 140 contains one or more types of connected elements 210, 220, 230, 240 for the monitoring or management of the structure. These connected elements 210, 220, 230, 240 communicate via wired 250 or wireless 260 networks and make the data structures from each connected element available to the HCDAS 125 and/or the cloud environment 120 via the network connections 150.

Any variety of connected elements may be used to perform sensing, actuation, data capture, storage, or processing over the network connection 150, to the HCDAS 125, cloud computing environment 120, to other parts of the system. For example, connected elements may be connected sensors to measure carbon dioxide 210 for monitoring air quality of the building 140 and communicate via a wired network connection 250. Connected element may be both a connected sensor to detect ambient light and also an actuator 220 to change the state of an occupant light fixture and communicate via a wired network connection 250. Connected elements may be connected sensors for temperature and humidity 230 to monitor environment of the building 140 and communicate via a wireless network connection 260. Finally, connected element 240 serves as a connected gateway to communicate with the associated connected elements 210, 220, 230, via their respective network connections 250, 260, process the data structures of each, and transmit same to a network connection 150 for transmission to the cloud environment 120. It should be appreciated a cloud computing environment 120, while providing additional communication paths to additional devices or systems, is not required as part of the semantic search method. Other embodiments contemplate self-contained or stand-alone systems.

These connected elements need not be geographically localized or logically grouped in any way to utilize embodiments of this disclosure. Grouping connected elements geographically or logically may allow more economic use. A geographic grouping such as in an apartment, home or office building may be accomplished, as well as logically locating connected elements by function. One of many logical grouping examples may be locating connected end points designed to sense temperature, proximate to an occupied location to detect changes in environment. It should be appreciated that the groupings of connected endpoints may also be located on a very large geographic scale, even globally. Such global operations may be monitored through a network located in any number of facilities around the globe.

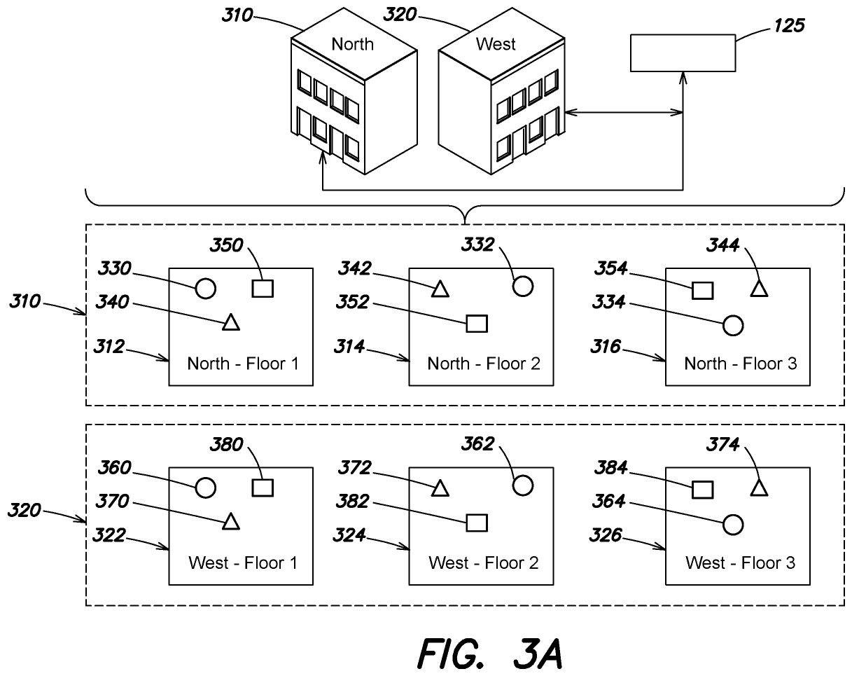

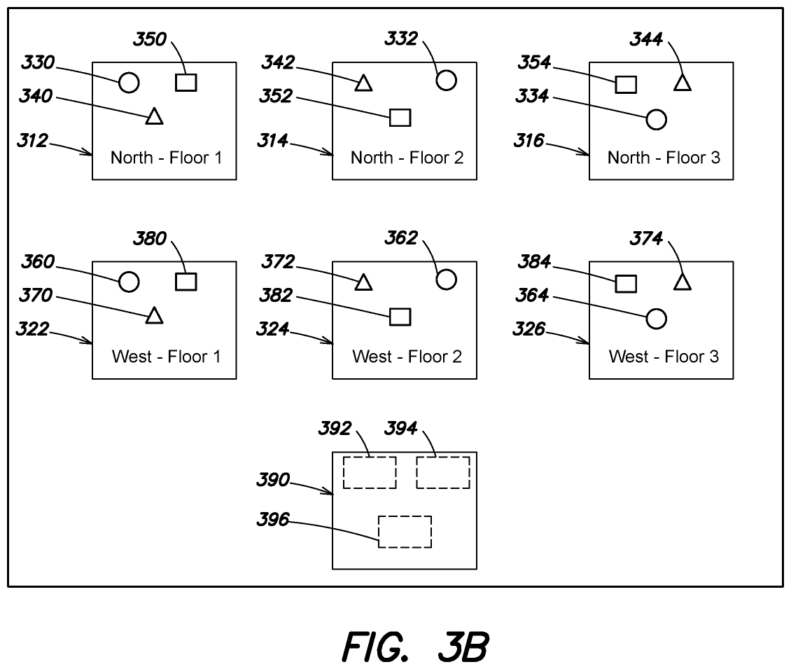

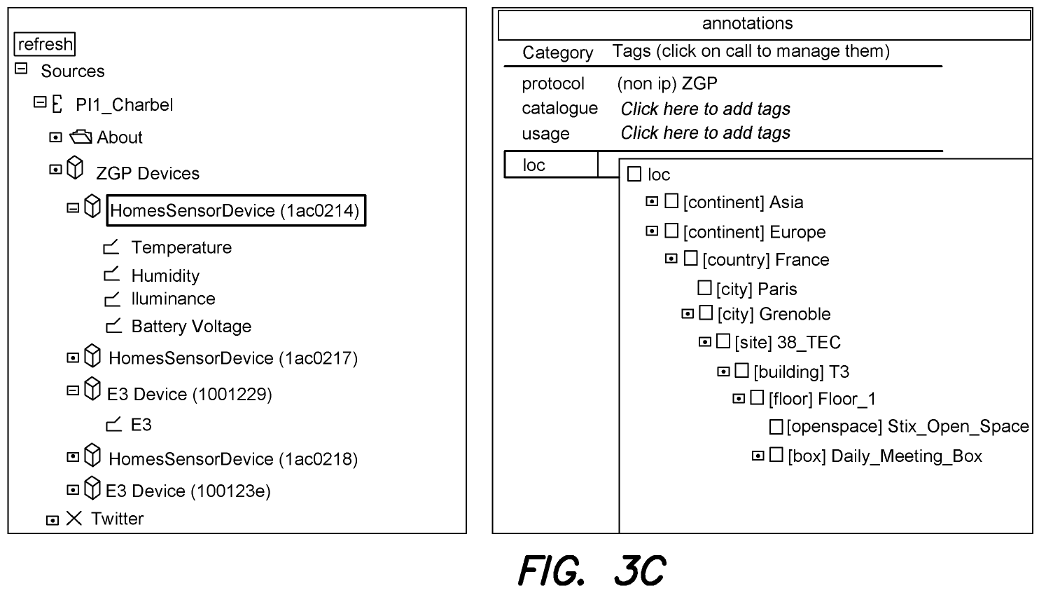

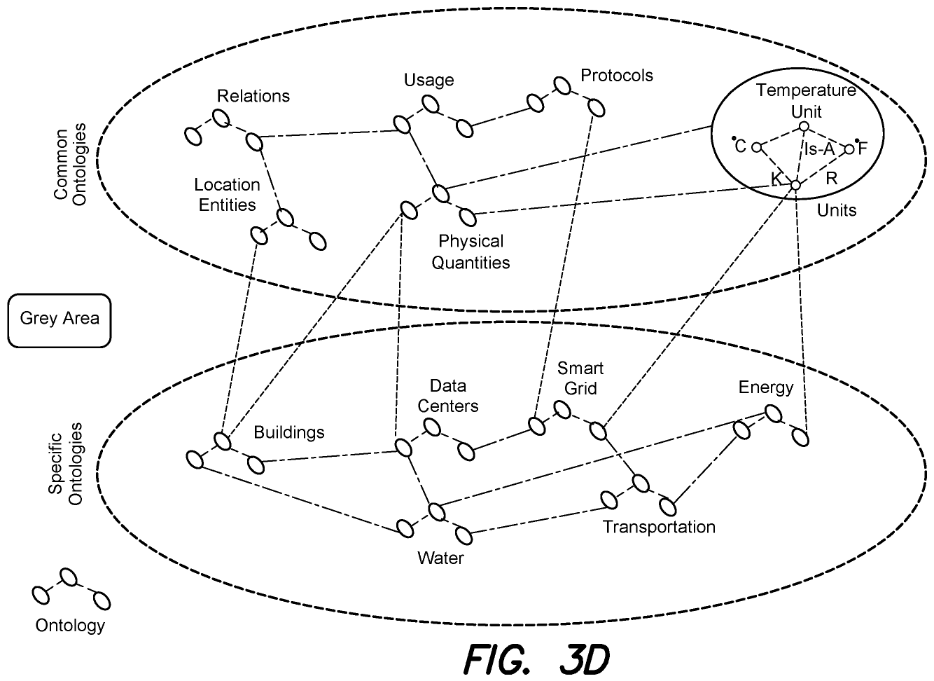

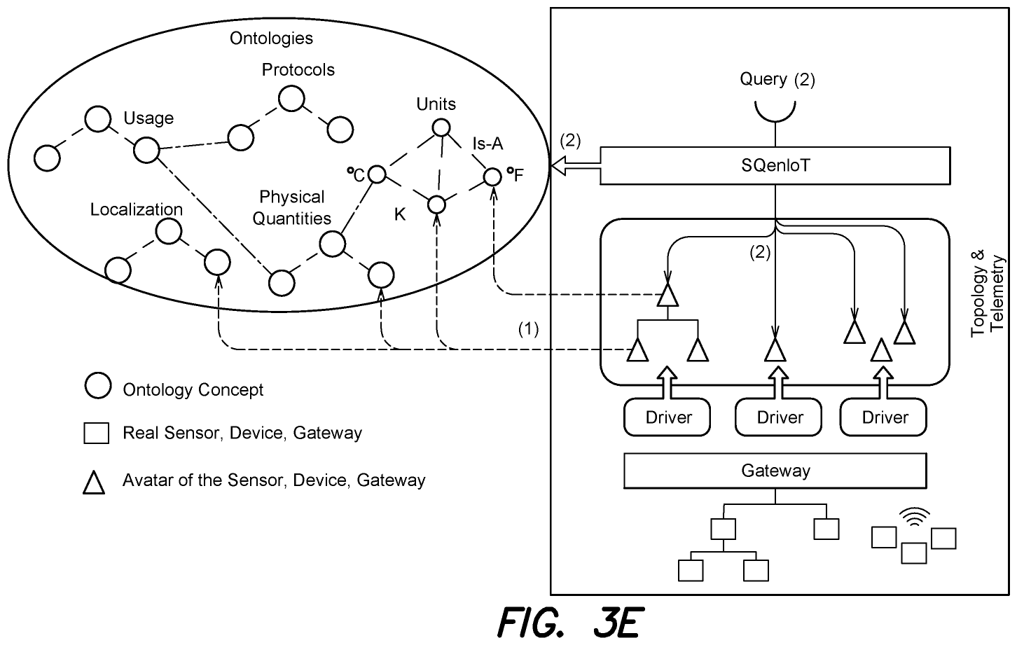

FIG. 3A illustrates an exemplary deployment of various connected elements of a HCDAS in which various embodiments of the present disclosure may be implemented. A “North” building 310 and a “West” building 320 are illustrated. Each building has (3) floors. North Floor (1) 312, North Floor (2) 314, North Floor (3) 316 are contained within the North building 310. West Floor (1) 322, West Floor (2) 324, and West Floor (3) 326 are contained within the West building 320. Each floor has (3) connected elements of different types. For example, connected elements may be connected sensors to measure carbon dioxide 330, 332, 334, 360, 362, 364 for monitoring air quality of the building 310, 320 respectively and communicate via a wired network connection. Connected elements may be both a connected sensor to detect ambient light and an actuator 340, 342, 344, 370, 372, 374 to change the state of an occupant light fixture and communicate via a wired network connection. Connected elements may be connected sensors for temperature and humidity 350, 352, 354, 380, 382, 384 to monitor environment of the building 310, 320 respectively and communicate via a wireless network connection. As illustrated a HCDAS 125 is connected to the system to provide semantic querying and operational rules to the connected elements to effectuate changes on the system.

FIG. 3B illustrates exemplary deployment of connected elements across a variety of physical locations of a HCDAS from FIG. 3A in which various embodiments of the present disclosure may be implemented. Within each floor of each building multiple connected elements exist. As an example, temperature and humidity 350, 352, 354, 380, 382, 384 carbon dioxide 330, 332, 334, 360, 362, 364, and ambient light 340, 342, 344, 370, 372, 374 connected elements exist on each floor of each building. Further, each connected element may exist in a distinct zone on each floor of each building. As one of many examples, a general floor plan 390 may indicate zones that are defined as “Zone 1” 392, “Zone 2” 394, and “Zone 3” 396. It should be appreciated that such designations are highly configurable by a user or other system and are shown here for illustrative purposes only.

Given the connected element configuration illustrated in FIGS. 3A and 3B, each connected element possesses a data structure that includes, but not be limited to, sensor specific information (temperature/humidity, carbon dioxide, and ambient light), geographic information (zone, floor, building), and network information (MAC address, IP address, wired, wireless). Other connected element information may be available as well as information relative to the operation of the connected element itself. As one example, a status of online or offline may be available to further add to the data construct for each connected element.

Once physical connections to the connected elements are put in place or established, a digital representation may be created. This process of translating the physical representation of the system to a homogenized taxonomy is called semantic tagging. Semantic tagging links the data structures available from the connected elements of a particular system to a formal naming and definition that actually or possibly exist in physically represented systems, or ontology. For example, ontologies may include definitions such as location, relationships, usage, physical quantities, network protocol, or units.

Semantic tagging may occur in one of two ways, automatic or manual semantic tagging. Automatic semantic tagging is accomplished by the system without user input. In this approach, each data structure for each connected element is examined and deconstructed by the system into corresponding data structure elements. During the identification process, it is determined what data structure elements exist for each connected element. Once each data structure element is defined, it is then mapped to a corresponding taxonomy and tagged with this taxonomy which in turn becomes part of that connect elements data structure. At least one data structure elements may be tagged during this process to allow all connected elements to be defined as part of the system.

Manual semantic tagging is accomplished by the system with user input. As an example, this form of tagging may be performed during the installation of the system as whole, groups of connected elements, or individual connected elements. Similar to automatic semantic tagging each data structure for each connected element is examined or known to a user. Once the user identifies what data structure element is defined, a user may then select a mapping to a corresponding taxonomy. Once tagged with this taxonomy it in turn becomes part of that connected elements data structure. At least one data structure element may be tagged during this process to allow all connected elements to be defined as part of the system. Other tools may be available to assist the user in identification of the particular data structure elements for the particular connected elements. Such tools may be used during commissioning of the entire system or portions of the system. It should be appreciated a HCDAS 125 is closely coupled with this system to allow the semantic operations described to be effectuated.

FIG. 3C illustrates exemplary hierarchical data organization constructs within a user interface of connected elements across a HCDAS. It should be appreciated that any connected element type in any combination may exist in any geographic location and include additional information within a respective data structure. Further, such hierarchy data organization illustrates exemplary output from a user interface which may be used to facilitate manual semantic tagging.

FIG. 3D illustrates exemplary ontological data organization constructs of connected elements across a HCDAS. These exemplary data organizations illustrate examples of ontologies such as protocols or usage as well as ontologies specific to the application such as data center or buildings. In this way, a facility operator is not required to have intimate knowledge of machine centric constructs, only human centric constructs such as usage, geography, physical quantities, and/or unit types, among others.

FIG. 3E illustrates exemplary control systems utilizing an ontological data construct and connected elements across embodiments of a HCDAS. A control system is now formed which utilizes elements of a HCDAS system to give human interpretable context to a physical and/or virtual system. An example is illustrative where a lighting technician is required to change lighting every Monday. Utilizing principals of ontological contexts, a technician may query via a HCDAS what “lights in the north building, floor 2” 314 require inspection. A technician need not understand a machine centric concept, such as serial number, but a human centric concept, such as physical location.

It should be appreciated these constructs are dynamic, as are the systems a HCDAS interacts with. In this way a user, or system may begin with a semantic query and utilize results of that semantic query to effect changes to a system under the purview of an HCDAS. Further, these query results may be used to form the basis for operational rules to further effectuate changes in a system and continue by a HCDAS executing operational rules and deriving results to be fed back to the semantic query portion of the HCDAS system.

Once the process of semantic tagging is completed, a digital representation of the physical system is stored in one or more memory within the system. Each connected element will be represented by a corresponding data structure. Each data structure will contain data structure elements that describe the characteristics of the connected element. As one of many examples, the connected element possessing a carbon dioxide sensor 330, will possess an associated data structure describing the characteristics of the sensor. Each data structure will be composed of a number of data structure elements. Each connected element will possess a data contracture and one or more data structure elements. Data structure elements for this carbon dioxide sensor 330 may include, physical quantities (carbon dioxide), measured units (Parts Per Million), location (North Building, Floor 1, Zone 3), protocol (MODBUS), network (wired, IP address), and usage (buildings).

It should be appreciated that while each connected element will have an associated data structure, the number of data structure elements may vary based on the particular configuration or application. Once the connected elements data structures are organized in this way, multi-dimensional analysis may be performed without discrete or in-depth knowledge of the physical system and the associated connected elements.

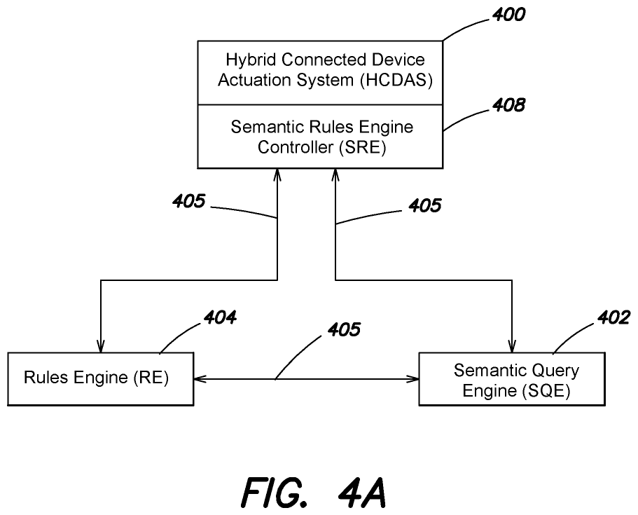

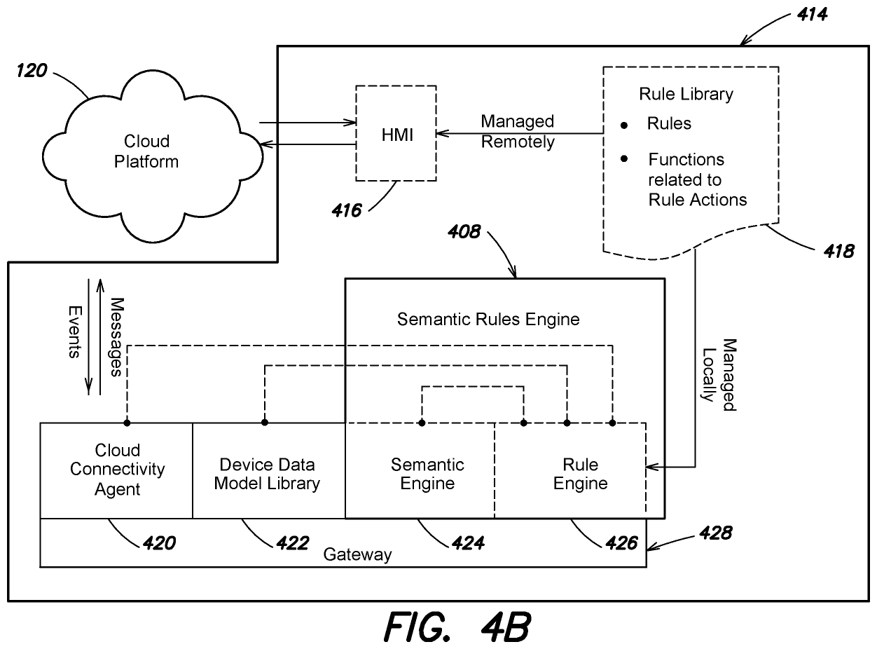

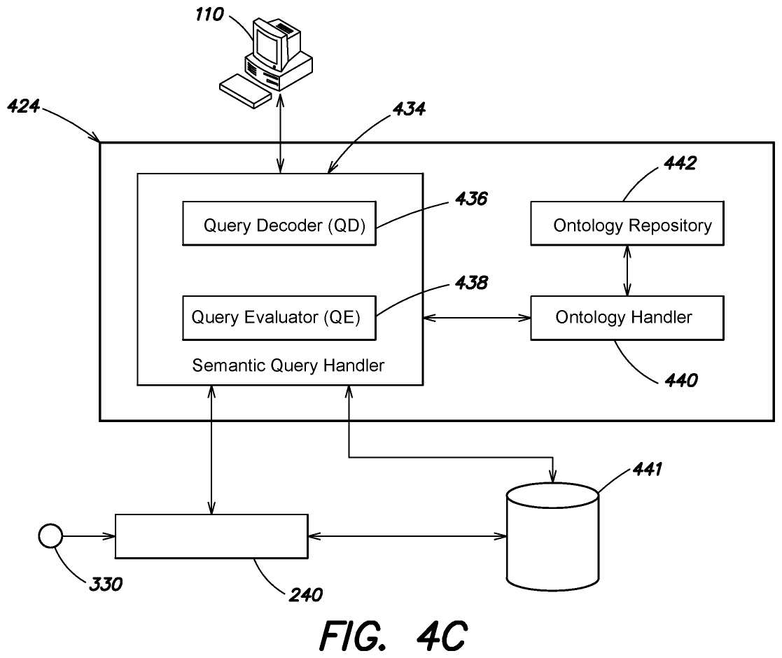

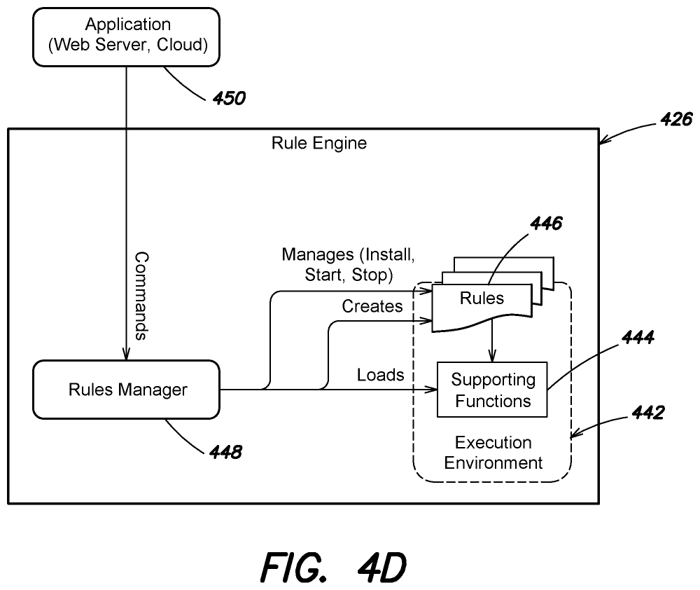

FIG. 4A is a block diagram of components and interconnections of a HCDAS. In one embodiment an HCDAS contains a semantic engine 402 and a rules engine 404, each is described in context in detail herein. It should be appreciated the semantic engine 402 and a rules engine 404 are in communication via network connections 405 both with each other and with the HCDAS. It is through this closely bound communication that the semantic engine 402 obtains results for the rules engine 404 to effectuate. Further results from the rules engine 404 are used to effectuate semantic queries used at the semantic engine 402. It should be appreciated this is more than a passing of results from one portion of the HDCAS to another, but rather an interrelation between them which facilitates many of the benefits described herein.

A semantic rule engine controller may be comprised of two parts, a rule engine and semantic engine. While both may be used in conjunction with each other, it should be appreciated this is not a limitation of the system and one or both may be used independent of the other.

A semantic rule engine controller 408 (depending on the implementation this may also be called a HCDAS controller 408) may include the following features: (1) utilize operational rules to explicitly express user and/or system requirements and conditions in an unambiguous and contextual manner; (2) utilize the capability of a device (e.g. a gateway) to deploy operational rules either locally and/or remotely; (3) dedicated operational rules execution engine to analyze, create, and/or execute the operational rules; (4) utilize SemanticWeb and Ontology concepts to provide consistent, reusable and shareable views regarding the data; (5) query language which is contextual with a natural language-like grammar; (6) an efficient mechanism to analyze user and/or system queries; (7) develop a solution in a modular way to integrate and extend with new functionality in the future.

With the semantic rule engine controller 408 any user and/or system requirements, regarding control or information, are expressed in the form of operational rules. These rules are designed so that they are able to: (1) evaluate conditions related to resources and/or their capabilities; (2) perform control of resources and/or capabilities when these conditions are met; (3) notify a user and/or system when a certain condition has been met; (4) provide a life-cycle to each rule that allows the rule to be installed, activated, deactivated, and/or uninstalled; (5) cooperation between rules allowing for, in one example, multiple rules to reuse the same articulation definition.

FIG. 4B is a block diagram of an embodiment of components of the system for a HCDAS. In the present example a HCDAS 414 consists of a Human Machine Interface (HMI) 416, a rule library 418, cloud connectivity agent 420, device data model library 422, gateway 428, and a semantic rule engine controller 408 which itself consists if a semantic engine 424 and rule engine 426. A cloud platform 120 may also be present to effectuate transfer of data remotely.

A HMI 416 may be utilized by a user and/or system to interact with the HDCAS 414. Principles of the disclosure contemplate the manual, semi-automated, and/or automated operation of a HDCAS 414, in part via the HMI 416 to accept and transmit information. A rule library 418 is a repository of operational rules created, generated, edited, and/or otherwise transacted by the semantic rules engine 408. These rules may be managed locally, remotely, or a combination of both. A cloud connectivity agent 420 is a supporting function of the HCDAS 414 and assists in rule management with functions such as subscriptions, timers and/or the interactions with other components of HDCAS 414. Additionally, the device data model library 422 is a repository of devices and capabilities available to the HDCAS 414 via a gateway 428. It should be appreciated the device data model library 422 need not contain only devices currently in use by the HDCAS 414, but may contain a complete library of functions for all available devices generally.

FIG. 4C is a block diagram of an embodiment of components of the system for a HCDAS including detail of a semantic engine 424. It is possible for either a user and/or another process from a machine to begin a semantic search. A user-initiated search may begin at a general-purpose computer 110, in other implementations a machine-initiated process may derive from any other process in the system. It should be appreciated the methods of initiation of a semantic search are not mutually exclusive from each other. In both cases, the query processed by the semantic engine 424, is a structured search query with a particular grammar. This grammar structure may include the use of various data structure elements, filtering, basic aggregation, publish and subscribe, and inferential functions.

In one embodiment, a structured search query may include one or more filtering expressions. Search Device protocol: ZigBee and quantity: temperature and location: Lab101 With (name==TempSensor and value>22 and with unit==_F) will search for ZigBee wireless sensors in Lab 101 named “TempSensor” with values greater than 22 F. In an alternate embodiment, basic aggregation functions are supported such as Min, Max, Sum, Avg. For example, Sum Variable measures:ActiveEnergy and usage:Lighting and location:Building2 calculates the sum of all active lighting sources in Building 2. In another embodiment, Publish and/or Subscribe functionalities, may be applied to connected elements in a specific location for a given measurement type. Subscribe Device protocol:zigbee and quantity: temperature and location: Floor] with value>22 and with unit==_F every 00:10:00 from 2016 Mar. 21 to 2016 Apr. 21, analyses when particular connected elements become available. In another embodiment, inferential functions such as @type:sensor may be used to infer relationships between connected elements.

Structured search queries are received into Semantic Query Handler 434, which is composed of the Query Decoder (QD) 436 and the Query Evaluator (QE) 438. The Query Decoder (QD) 436 analyses the structured search query and deconstructs it into query elements.

Query elements are passed to the Query Evaluator (QE) 438, to analyze the query elements and perform operations on the system based on the analysis. A structured search query may include an inferential function regarding a particular connected element. In this case the discrete connected element is not known, but information regarding same is requested. Here, further analysis is performed by the Ontology Handler 440, which further processes the data structure elements for the inferential reference contained in the structured search query and accesses the Ontology Repository 442 for the available inferential references to the appropriate connected elements.

For example, a connected element is a carbon dioxide sensor 330 queried by a user for the value of the environment. A user inputs a structured query into a general-purpose computer 110. The Query Decoder (QD) 436 decompiles the structured search query and passes the query elements to the Query Evaluator (QE) 438 that performs operations to collect the data. In this example, only the current value of carbon dioxide at the sensor 330 is requested. The Query Evaluator (QE) 438, requests the complete data structure for the connected element. This data structure is transmitted from the connected element acting as a gateway device 240 for the carbon dioxide sensor 330. The entire data structure of the carbon dioxide sensor 330 is collected from the connected element acting as a gateway device 240 and the data is transmitted to the Semantic Query Handler 434 and to the general-purpose computer 110. It should be appreciated that the data structures for analysis may be from near real time connected elements such as the connected element acting as a gateway device 240 or data repositories 441 which contain the data structures. Such decisions are based on state of the system and the structured search query. As described supra, the semantic engine 432, is one component of the HCDAS 414 and is closely coupled with the rule engine described in FIG. 4D.

FIG. 4D is a rules engine example of an implementation of components of the system for a semantic search method in accordance with various embodiments of this disclosure. As described supra, the rules engine 426 is the other component of the semantic rules engine controller 408. It in part, provides gateway to connected elements with the decentralized intelligence and/or the ability to manage, monitor, and/or control any connected devices be it physical, virtual, or a combination of the two.

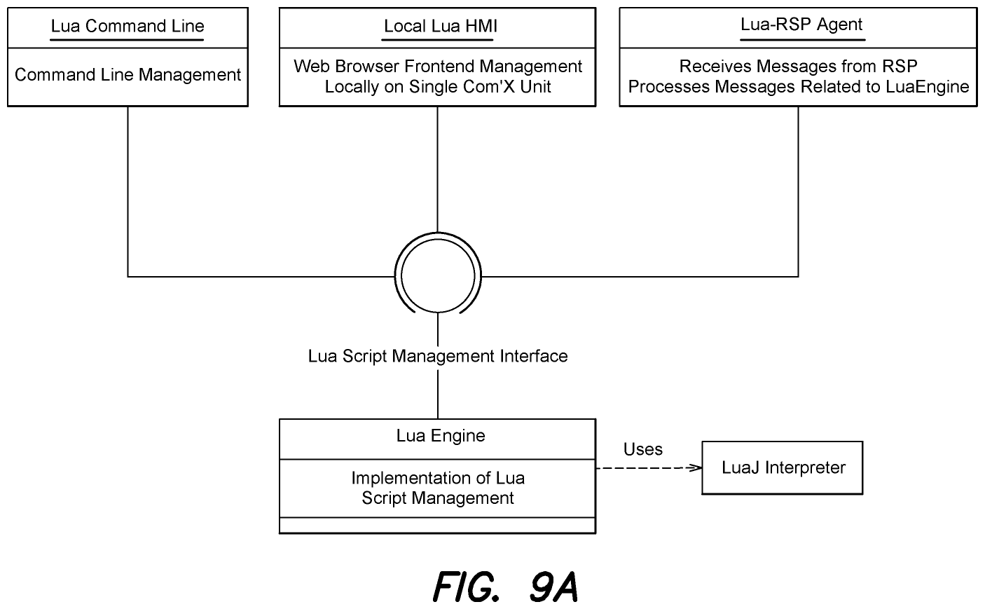

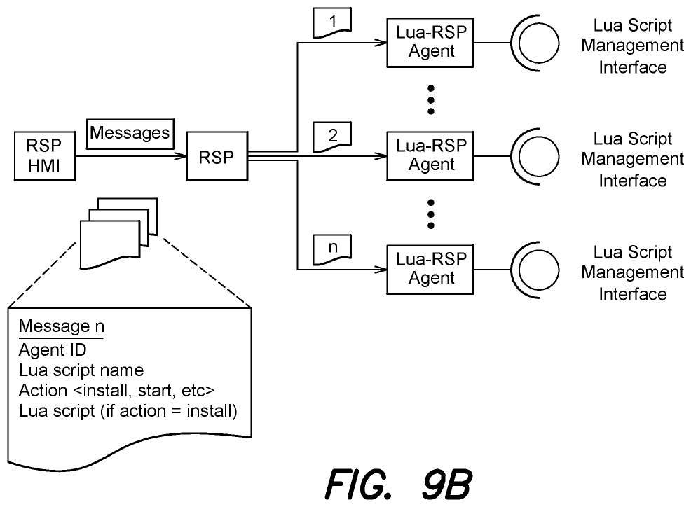

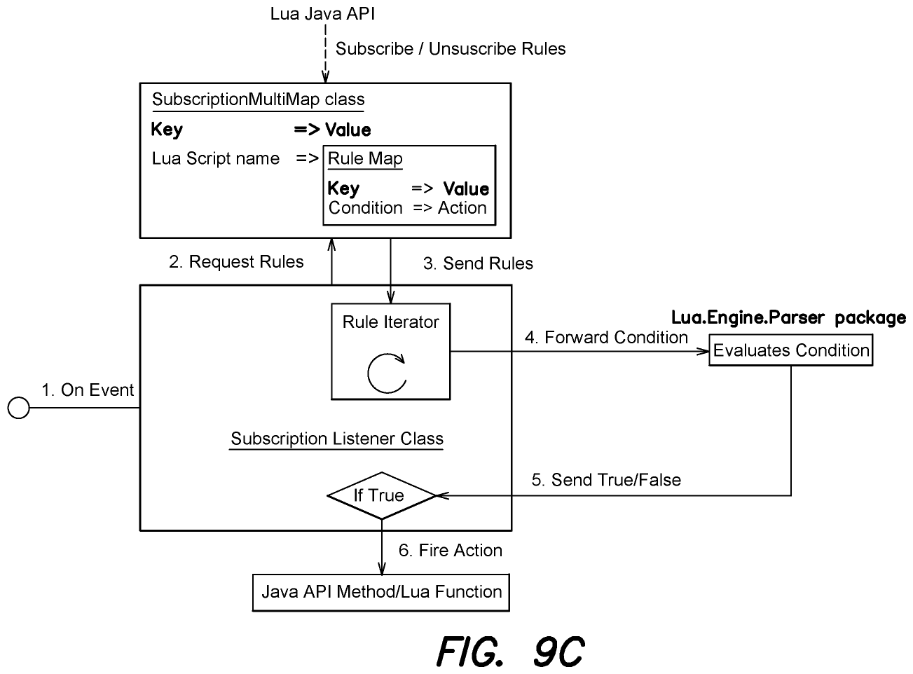

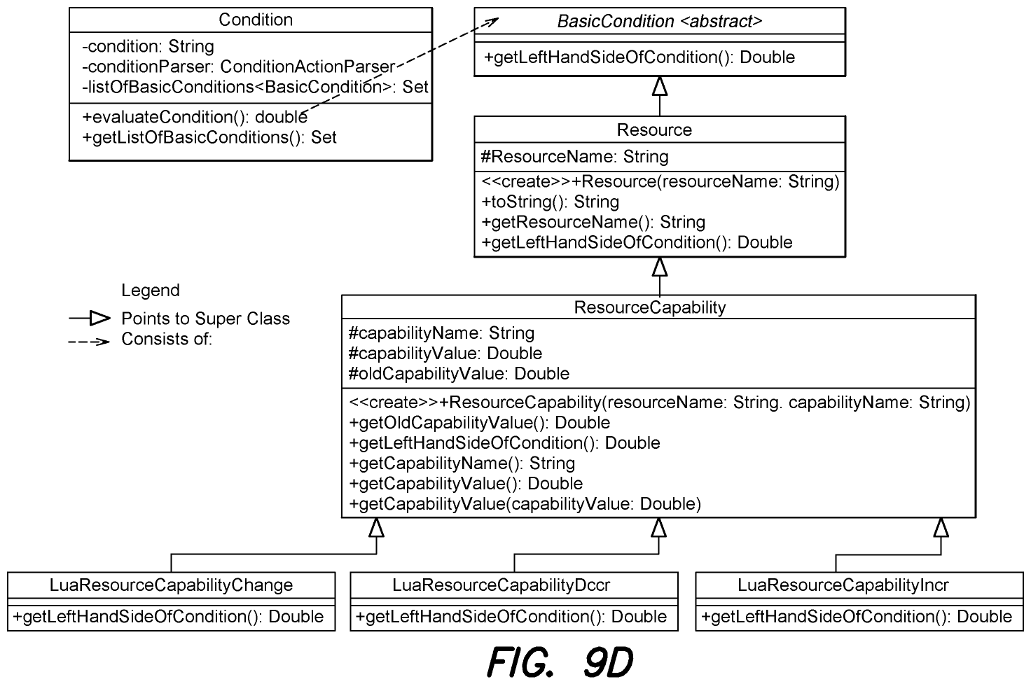

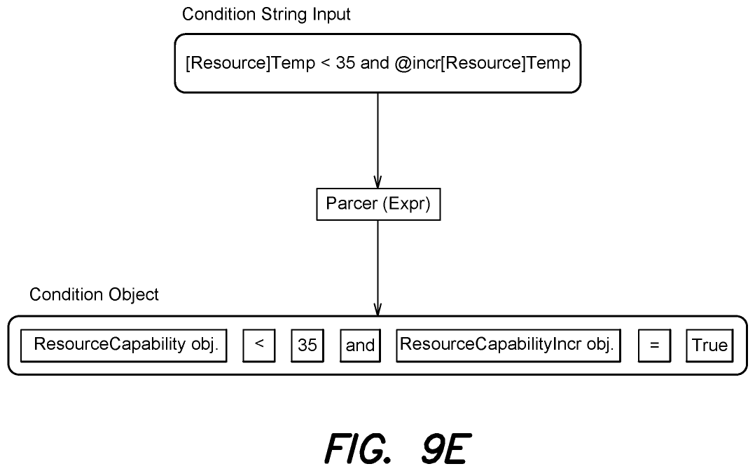

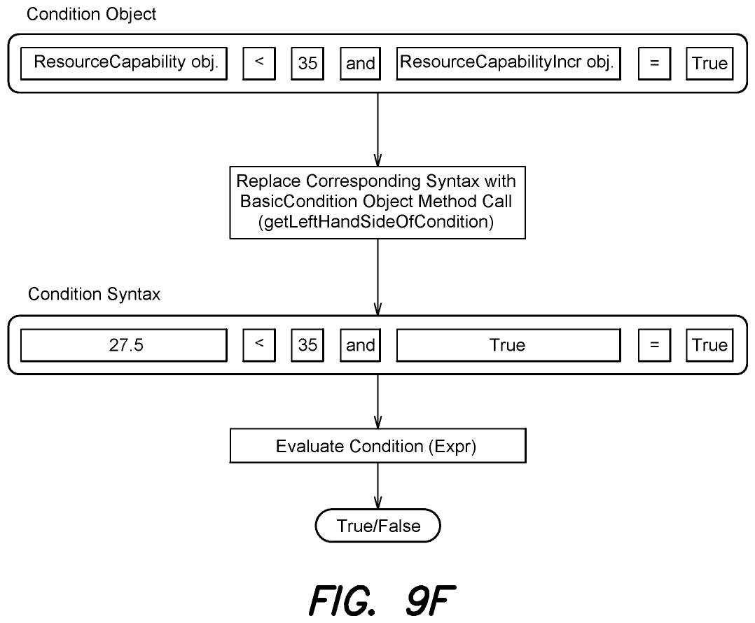

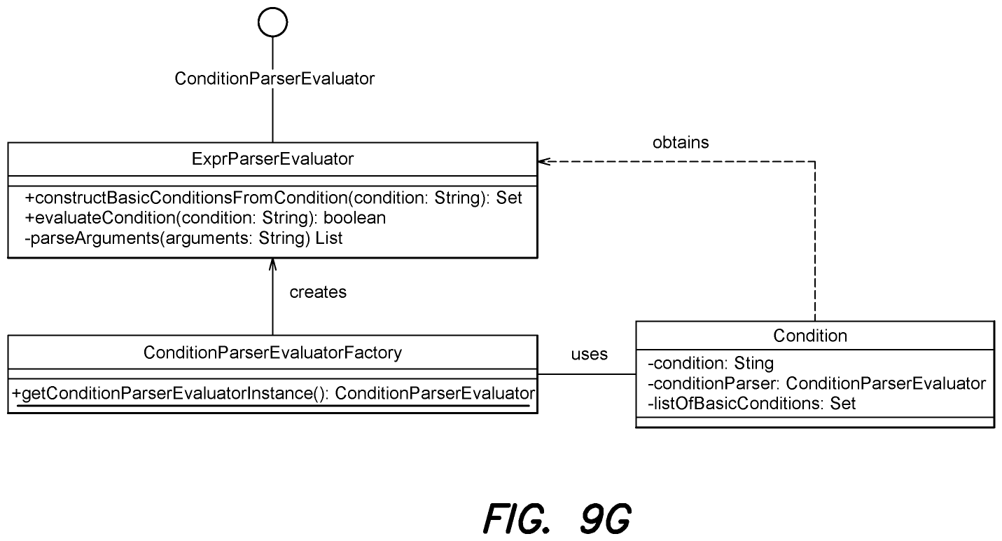

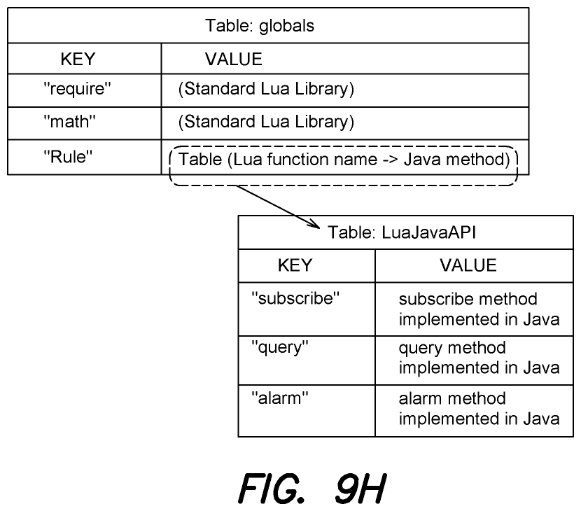

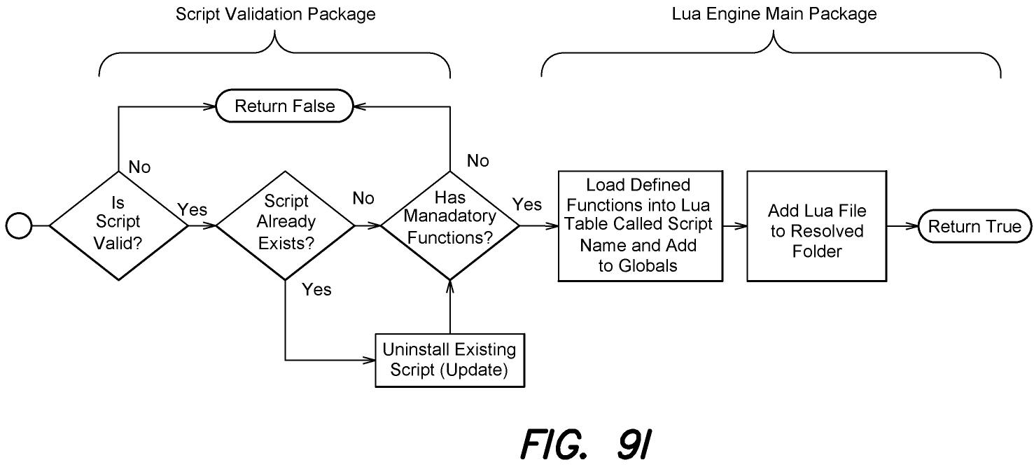

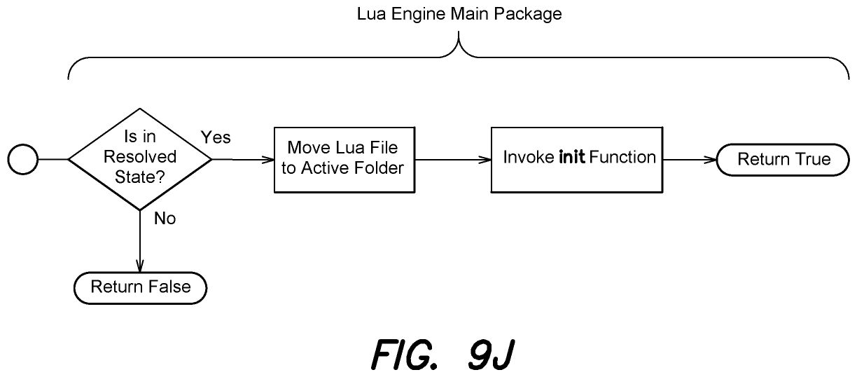

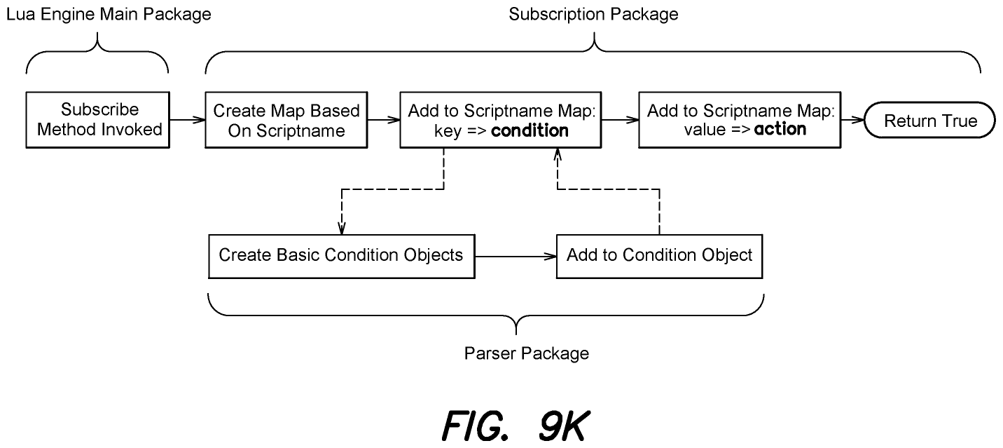

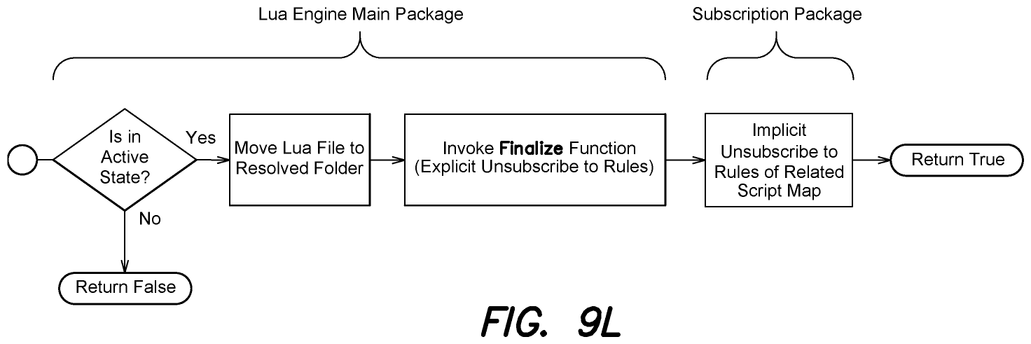

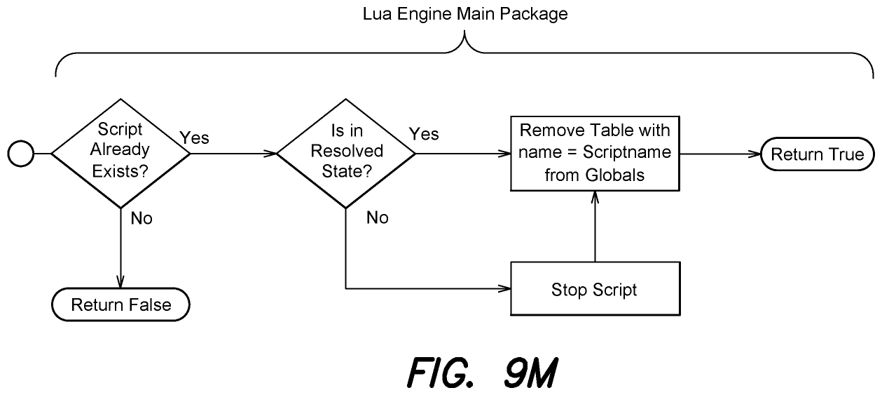

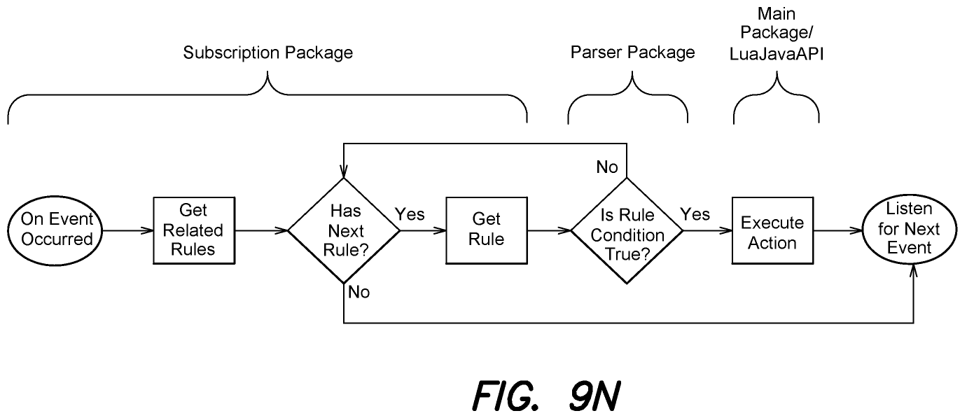

A rules manager module 448 may interact with the remote applications to receive rule files and/or commands to manage them. A rules manager loads the execution environment to run and manage all the rules. An execution environment is typically a set of supporting functions that are needed to provide the required functionality. These supporting functions 444 handle subscriptions, the timers and interactions with other components of semantic rule engine controller 408 such as the semantic engine 424 and cloud connectivity agent 420. Each of these functions may reside in an execution environment 442 to allow operation. Particular examples of this operational environment are illustrated in FIGS. 9A-9N. Once the execution environment is created, the rules manager can create rules 446 and manage them (e.g. install, start, stop and/or delete). Each operational rule may be executed in isolation so that any anomalies with one rule does not affect others. Operational rules may interact with an application layer such as a web server or cloud 450 for enhanced remote capabilities. Such interaction may take the form of an HMI via a web page to issue instructions and/or commands to the HCDAS 414.

In order to administer rules in a contextual basis, the semantic search engine 424, detailed supra, may be used. A concept of the semantic search engine 424 is utilized to allow the rule engine 426 to make semantic based queries and use returned results to execute rules. It should be appreciated, the linkage between the semantic search engine 424 and rule engine 426 are utilized to bring many of the benefits of this disclosure.

The provided simple query language greatly facilitates this interaction between the two Engines. This is a differentiating factor from other solutions such as If This Then That (IFTTT). As one of many examples, a rule may use a location tag as a means to obtain a list of sensors to make comparison of their current values against a threshold specified in a rule. A semantic search engine may do the filtering of all the sensors using the location tag and provides only the relevant ones to the Rules Engine as result. An operational rule may then do the comparison on any results and execute an action, for example, notification, alarm, and/or an actuation, according to the logic specified in the rule.

In an alternate embodiment the same rule may be executed periodically and before its next execution, some new sensors are installed in the same location. Use of a semantic engine will return both new and old sensors when executing the same semantic query in its next execution. Hence, there is no need to change the rule logic. In this example, the rule engine becomes independent of any topology change.

Overall, having this capability allows the semantic rule engine controller to become a flexible solution in which the same rules may be reused in different products and solutions as long as the concepts (such as location in above embodiment) are similar. This provides several benefits including but not limited to, time and cost savings, similar functionality irrespective of device, installation or customer.

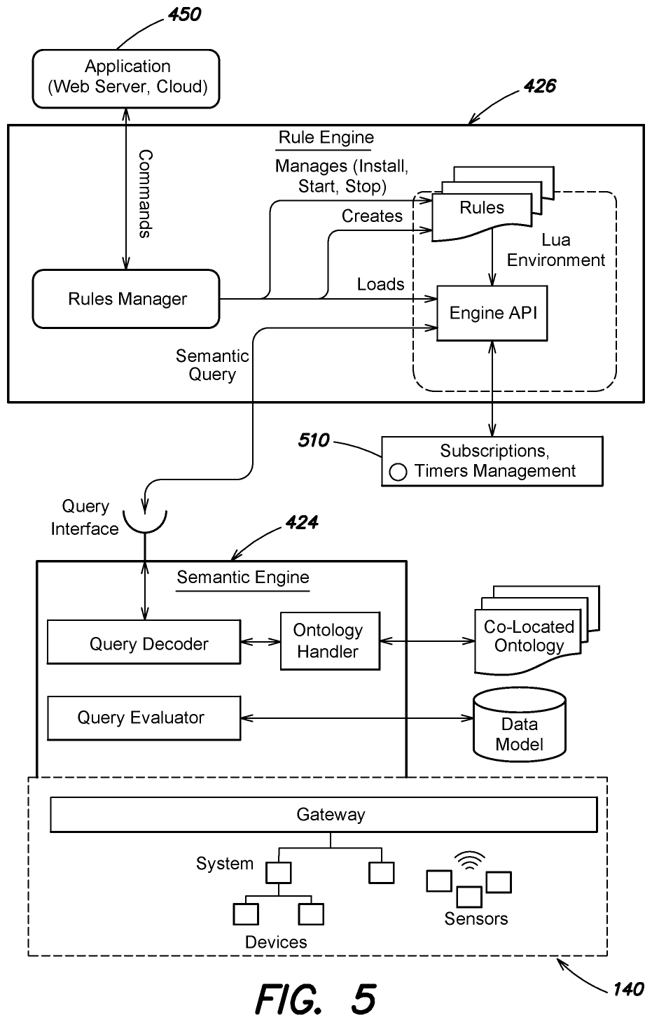

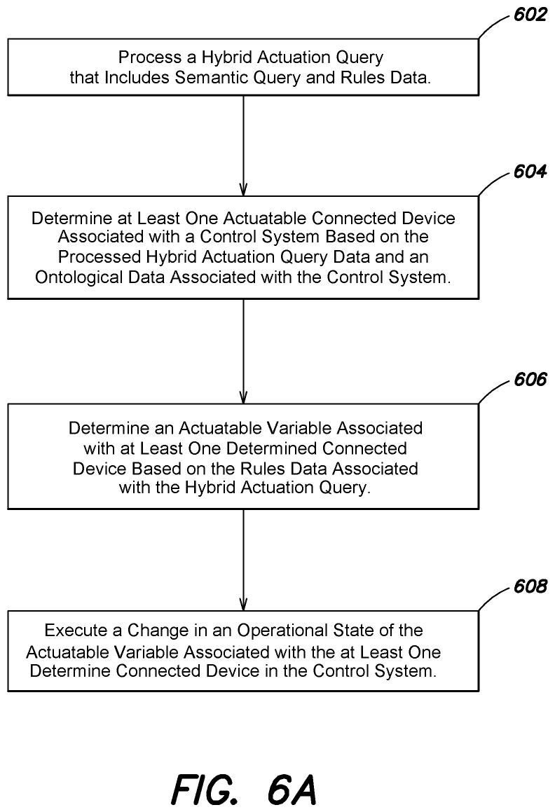

FIG. 5 is a block diagram of an embodiment of components of the system for a HCDAS including detail of a semantic engine 424 and a rule engine 426. Additionally, connected devices and associated elements from a building 140 are connected. Further a rules management module 510, described supra is contemplated which may include, but are not limited to subscriptions, timers, and/or other management. Operational rules may interact with an application layer such as a web server or cloud 450 for enhanced remote capabilities. Such interaction may take the form of an HMI via a web page to issue instructions and/or commands to the HCDAS 414.

As one example utilizing this embodiment, a maintenance person has a task of replacing light bulbs that are non-operational every Monday morning. A user may use an HMI associated with an application 450 to query a geographic location for non-functioning light bulbs. An operational rule may exist for same already located in components of the rule engine 426. If so, results of the operational rule would be made available in human understandable format (e.g. lightbulb is out in North building, floor 2, office 5). If no rule is available, a user may make such a query from the semantic engine 424. Once results are obtained, the HCDAS may make or suggest an operational rule be made for same.

The technician may now perform the maintenance work in human centric terms and in subsequent weeks, the HCDAS itself may update the operational rule to include or exclude lights based on a semantic search it would conduct itself. In this way the semantic 424 and rule engine 426 are tightly bound to each other to provide, feedback, and update results, controls, and/or operational rules.

User and/or system requirements, regarding control and/or information, are expressed in the form of operational rules. As such the rules may be designed with the following characteristics: (1) evaluate conditions related to resources and/or their capabilities; (2) perform control of resources and/or capabilities when these conditions are met; (3) notify a user when a certain condition has been met; (4) provide a life-cycle to each rule that allows the rule to be installed, activated, deactivated and/or uninstalled; (5) cooperation between rules allowing for, as one of many examples, multiple rules to re-use the same articulation definition.

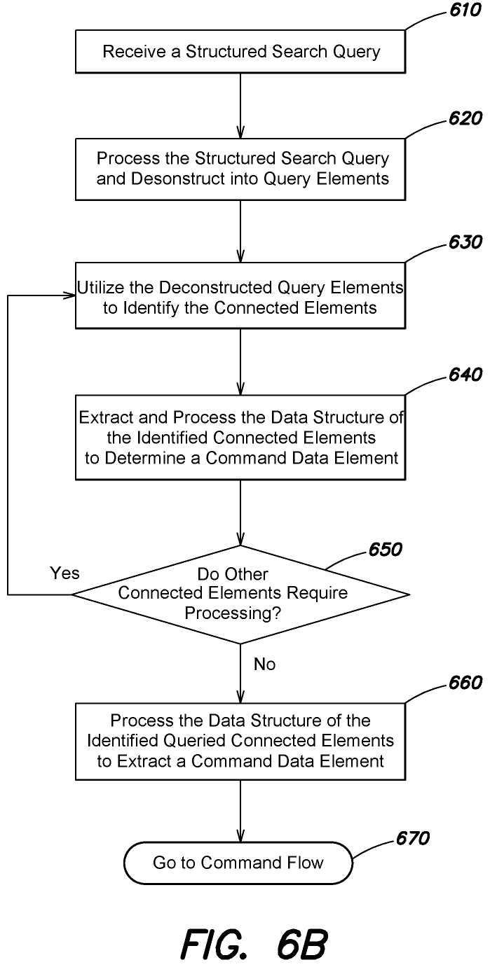

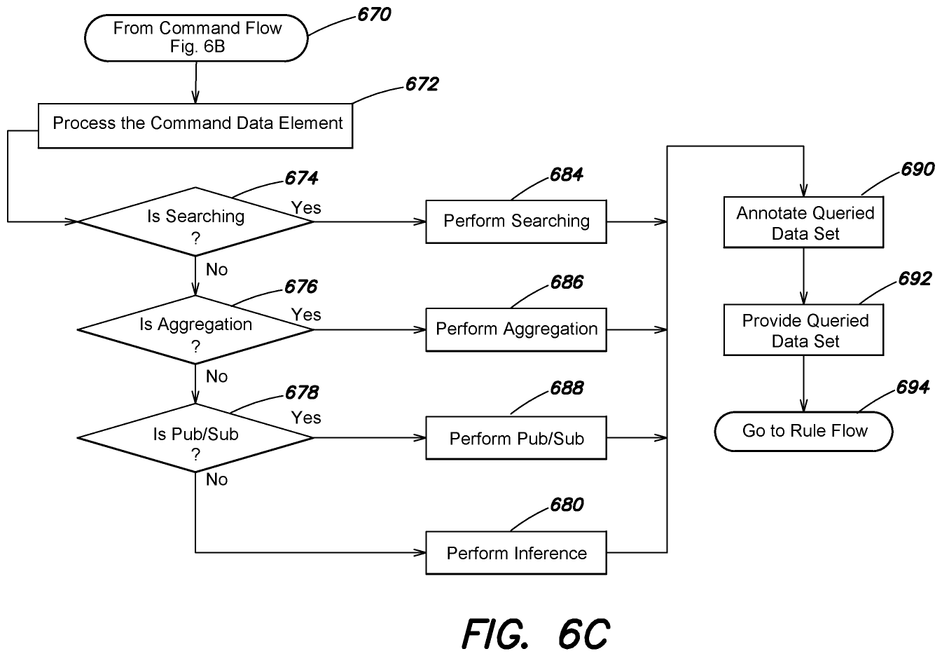

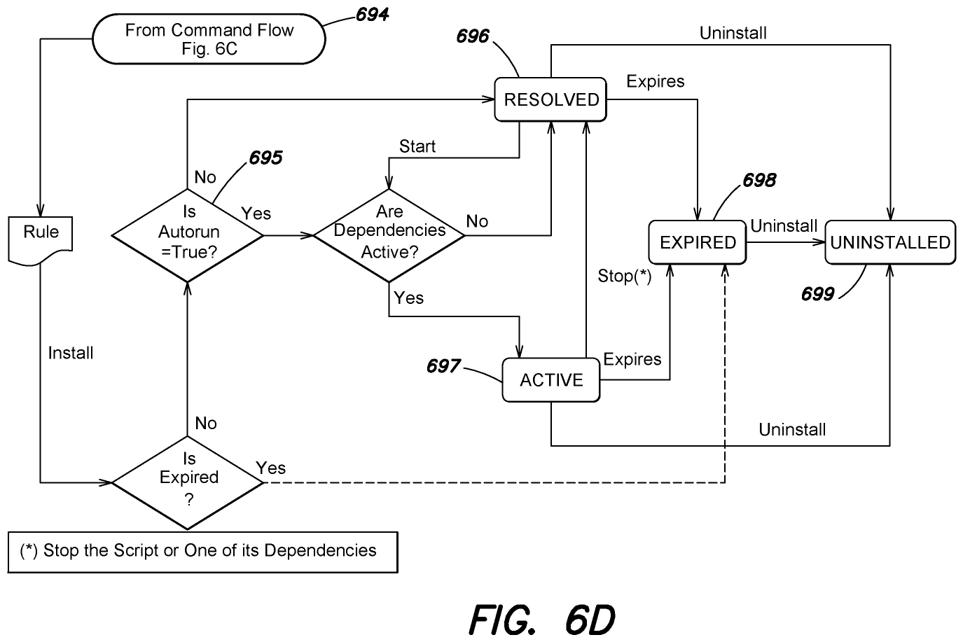

FIG. 6A is a flow diagram for executing a HCDAS. As detailed herein the HCDAS processes a hybrid actuation query that includes semantic query and rules data 602. It should be appreciated this query may come from the semantic engine, rules engine, or of one being acted upon by the other to form a hybrid query aimed at the actuation of connected elements within the system.

At least one actuatable connected device associated with a control system based on the processed hybrid actuation query data and an ontological data associated with the control system is determined 604. This serves as identification of one or more connected elements associated with a query which may come from the semantic engine, rules engine, or of one being acted upon by the other to form a hybrid query aimed at the actuation of connected elements within the system.

Once one or more connected elements are determined, their capabilities need to be understood so any forthcoming actions are appropriate for the type of connected element requested to be acted upon. Determining, an actuatable variable associated with the at least one determined connected device based on the rules data associated with the hybrid actuation query 606 allows this characterization of the connect elements capabilities to occur.

As these are completed the HCDAS executes a change in an operational state of the actuatable variable associated with the at least one determined connected device in the control system 608 to effect the change to the one or more connected elements.

FIG. 6B is a flow diagram of exemplary command functions for a HCDAS. As discussed supra, a structured search query is received for one or more connected elements 610. It should be appreciated that one or more connected elements may be the target of the semantic search. This query is received directly from a user or another machine. One received, the structured search query is deconstructed into its composite query elements 620. Query elements are processed by the Semantic Search Engine to identify which of the connected elements require examination of their respective data structure 630. The data structure for each identified connected element extracted and processed to determine what data structured elements match the query elements of the structured search query and to determine a command data element 640. This command data element is used to determine additional processing required to complete the structured search query. Embodiments of the disclosure allow for analysis of multiple data structure elements of multiple data structures, which correspond to multiple connected elements. Decisions are made to determine if other processing is necessary 650. If not, processing is performed for the data structure on each identified connected element to determine the command data element for each identified connected element 660. Commands are then separated by type 670.

FIG. 6C is a flow diagram of exemplary command functions for a HCDAS from FIG. 6B. From FIG. 6B commands are separated by type 670. Command data is processed top determine further processing. These types include searching commands 674, aggregation commands 676, publishing and subscription commands 678, and localized inference commands. Once the determination is made, the command is carried out for searching 684, aggregation 686, publishing and subscription 688, and localized inference 680. Once the result of processing the commands is complete for all identified connected elements, annotation of the data is performed to form a queried data set 690. This queried data set is the result of the initial query along with any actions taken as part of the commands processed. This queried data set is provided 692 to the general-purpose computer to be used by the user and/or the system that made the initial query. Once the semantic engine completes its associated operations, processing continues with the rules engine flow 694 in FIG. 6D.

FIG. 6D illustrates a flow diagram of an embodiment of operational rule lifecycle operations for an HCDAS. One benefit of the operational rules is to be as flexible as possible in terms of their life cycle. As one of many examples, a rule that lowers the temperature of a hot water supply might only be activated over weekends and stopped afterwards. Embodiments of a rule lifecycle allow a user and/or system to fulfil requirements by managing the life-cycle states using Human to Machine Interfaces (HMI) such as a graphical user interface.

It should be appreciated that rules may interact with each other. Operational rule cooperation is where the action part of a rule will be contained within a function. The action may for example send an alarm with a certain string to a monitoring program or management platform. To specify a separate action for each rule that fulfils the same function would be redundant. Allowing cooperation between rules has a benefit of shared functionality reuse. One result may be less rule definition and allows a user and/or system to use existing functions instead of having to create a new function for each instance.

Regarding the action part of the operational rule, a design may be chosen to give the user as much freedom as possible in terms of the type of action to be performed. These actions may range from controlling devices, sending alarms and/or defining new rules. To achieve this, the idea of allowing the user to describe the action part as a custom function or a predefined function is envisioned.

One function of the operational rules is to be as flexible as possible in terms of activation or deactivating. As one example, a rule that lowers the temperature of a hot water geyser might only be activated over weekends and stopped afterwards. Rule lifecycles allow the user to easily fulfil this requirement by toggling the rule between its different lifecycle states using, for example, a HMI to perform this action. It should be appreciated these systems may also act autonomously or with a combination of user and system inputs.

Rules and lifecycles for rules have several possible states. These include, but are not limited to, set to run automatically 695, to be in a resolved state 696 if the rule is completed, in an active state 697, if components of the rule have yet to be evaluated, if a rule is expired 698 or otherwise completed operating, and/or if a rule has been deprecated and should be uninstalled 699. It should be appreciated the permutations of lifecycles for rules is vast given the ability to programmatically change their operation. Rule lifecycles by their nature are highly customizable for the particular environment.

As described previously the action part of a rule will be contained within a function. An action may be as generic as sending an alarm with a certain string to a monitoring center or management device. To specify a separate action for each rule that fulfils the same function would be redundant. Allowing co-operation between rules ensures that shared functionality is reused. One result is less rule definitions which allows the user or system to use existing functions instead of having to create a new function from scratch.

It should be appreciated from the foregoing; the use of structured semantic queries solves two distinct problems. First, is to solve the issue of data heterogeneity delivered from a connected system which contains various data structures. Second is to filter and aggregate this heterogeneous data from the connected elements and provide only required and relevant data to a user, cloud platform, or other repository. It should also be appreciated a semantic search may exist as a standalone system which receives data from any number of connected sources.

In an implementation, it is possible for an integrated solution—a HCDAS to analyze, create, develop, execute and control various connected devices utilizing executed operational rules. For example, the data generated by the semantic search engine may in turn be provided to the rules engine and harnessed through the development of operational rules executed dynamically by a semantic rules engine controller associated with a particular system to analyze, create, control and perform tasks on that system, or stored in a library or other repository and used on other systems.

In another implementation, the rule engine may exist as a standalone system and/or system module which receives data from any number of connected sources. Again, the semantic rules may be developed and executed to facilitate control of connected sources, as well as a control strategy on the selected system(s). This control strategy may be configured at run-time without disrupting the operation of the devices and rule life-cycle may be associated with any or all operational rules to allow robust management of the selected system(s).

Efficient energy management and specifically the problem of proper control and monitoring are of consideration. Present solutions do not address some, many, and/or all of these problems. Examples of functions identified which may not be present include, a method of expressing operational rules that can autonomously control devices, a method of expressing operational rules that notify a monitoring system via alarms when specific conditions are detected, a method of deploying these operational rules to the different units either locally or remotely, a rule engine that is capable of evaluating the operational rules, identification of devices and measurements based on their geo-location and metadata, and detection and resolution of conflicting operational rules.

Some examples include multiple sensors within the smart building environment that may be used to gather as much information as possible concerning the state of the environment. Based on these measurements the environment can be manipulated to reach a new desired state by controlling certain actuators. Furthermore, alarms may be activated and monitoring done using these measurements.

This control and monitoring can be achieved by specifying operational rules known as ECA (Event Condition Action) operational rules of the following format: when event E occurs if condition C==true then trigger action A, where:
An event prompts the evaluation of a rule. An example is a timer that runs out or a certain device that becomes available.
A condition specifies the part of the rule that is evaluated when the event occurs. An example is when a device measuring temperature registers a temperature above 30° C.
An action to be performed when the condition evaluates to true. An example of actions that performs control and monitoring respectively are:
   Set the air conditioning device temperature to 22 degrees Celsius.
   Send an alarm to the monitoring center specifying that a possible fire has been detected.

Operational rules that are created and/or edited are capable of being deployed on the various units in the field. Optimally this must be a simple and quick process so that the benefits of these operational rules can be observed as soon as possible. Furthermore, it may be possible to deploy the operational rules either locally (for example by a site commissioner) or remotely (reduces costs when new operational rules are deployed at a later stage). Once the operational rules have been deployed on the units, the rule engine of each unit may be responsible for managing these operational rules

A rule engine may reside on each of the units in the field, or be cloud based on virtual units. A rule engine may be capable of dynamically accepting and removing operational rules. A rule engine may be capable of an array of management needs to manage all operational rules deployed on it, or some sub set of operational rules while keeping track of which operational rules are activated or deactivated.

A rule engine may listen for events, and once an event is received the rule engine may then detect all, some, or none of the operational rules related to this event. It may then evaluate the condition part of each of these operational rules. Finally, the actions may be executed for the operational rules for which the evaluation was deemed true. Concerning the condition and action parts of the operational rules the following functionality may exist:
A rule engine may be capable of evaluating intricate conditions composed of logical and arithmetic comparators using values from multiple devices.
An action part of the rule should allow maximum flexibility to the user allowing from simple operations such as sending an alarm to more advanced operations such as control and even further definition of new operational rules.

Each unit in the field may be connected to a number of devices. These devices may not necessarily be connected at the same moment in time that unit is commissioned by a user and can possibly be added only at a much later stage. In short, configurations are dynamic in nature. Furthermore, it is not always evident what capabilities each of the devices possesses. To solve this problem an abstract language may be defined capable of identifying devices and their capabilities as well as indicating when a device becomes available or unavailable. This will allow the user to define operational rules that may not be tightly bound to specific devices, but rather to the properties describing devices, via the abstract language.

One possible example of how an abstract language can enhance a rule may be based on the average temperature measured within a building. If the rule is defined based on the current devices available at rule creation, when a new device measuring temperature is added to the building, the rule may not be aware of the new device. The present disclosure contemplates creation of the operational rules in such a way that they are independent of the devices at creation time and may be dependent on devices at evaluation time. Operational rules may furthermore be based on the properties of a device rather than a specific device itself.

Solutions may allow multiple stakeholders to add specific operational rules based on their needs. This increases the likelihood that certain states may be reached where operational rules might be in conflict with each other from the multiple users. This disclosure contemplates detection of these conflicts. Further, this conflict detection may be followed by a resolution policy that, for example, disallows operational rules, modifies the set of conflicting operational rules, and/or executes operational rules based on its salience and/or priority.

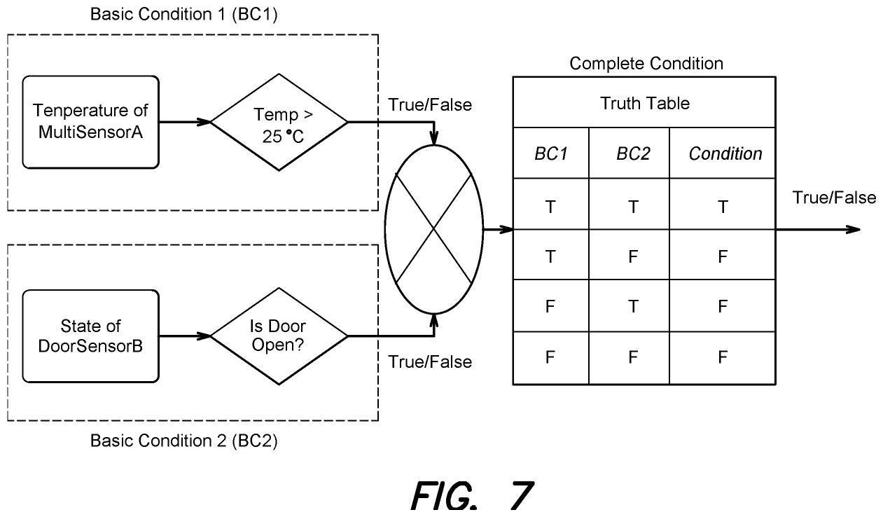

FIG. 7 illustrates a flow diagram of an embodiment of operational rule conditionality operations for an HCDAS. Operational rules may be designed to contain conditions. A condition part of an operational rule is designed to be very flexible. A condition may consist of the evaluation of multiple resources and/or capabilities. A basic condition may be defined as a condition that takes only one resource or capability into account. Therefore, the condition part of a rule may consist of the evaluation of multiple basic conditions combined by logical operators. As one example, syntax for obtaining a measurement of a device using the definitions of a resource and/or capability may be:

[Resource] Capability

and an example:

[MultiSensorA]Temperature

Based on the definition above, an example of how a condition can be composed of multiple basic conditions is as follows and illustrated in FIG. 7.

Condition: [MultiSensorA]Temp>25_C AND

[DoorSensorB]isOpen==True

BasicCondition1: [MultiSensorA]Temp>25_C

BasicCondition2: [DoorSensorB]isOpen==True

Examples of the logical operators that may be used are AND and/or OR. Examples of the comparators that may be used are: =;<;_;_;< >;>.

Various types of basic conditions are defined that allow expansive evaluation of resources and/or capabilities. These include, but are not limited to:

Resource Capability: ( )

This condition may be used when the current measurement of a specific resource and capability is of interest. An example syntax is: [MultiSensorA]Temp>25_C This allows evaluating when a capability has reached a certain threshold (<;_;_;>) or is equal/not equal to a specific value (=;< >).

Resource:

This condition allows specifying the “Resource is connected” event as a condition. An example syntax is: @exist[MultiSensorA]=True

ResourceCapabilityChange:

A need may extend beyond evaluation of only the current value of a measurement. A change in state and/or value of a capability may be of interest. This condition allows defining a change in a capability value. An example syntax is: @change[DoorSensor]DoorState=True This type of evaluation may be beneficial for capabilities that may indicate state, such as a measurement corresponding to whether a window is open or closed.

ResourceCapabilityIncr: The evaluation of condition ResourceCapabilityChange: may be further distinguished between an increasing and decreasing condition change. This condition evaluates to true whenever the capability value increases. An example syntax is: @ incr[MultiSensorA]Temperature=True

Resource CapabilityDecr: Similar to the condition ResourceCapabilityIncr: this condition may be utilized when a capability value decreases. An example syntax is: @decr[MultiSensorA]Temperature=True

An ability to combine a very large number of conditions via the logical operators AND and/or OR allows the user and/or system to specify beneficial conditions related to specific requirements. As the semantic search engine is context based and does not need to know the name of the resource and capability, any interest may be expressed by location, device type, protocol, and/or physical measurement capability. A semantic search engine will return corresponding resources matching these interests in a contextual manner.

Operational rules may have associated actions. Regarding the action part of the operational rule, a design may be chosen to give the user and/or system as much freedom as possible in terms of the type of action that can be performed. Example actions may include, but are not limited to, controlling devices, sending alarms and/or defining new operational rules. One method of achieving allowing a user and/or system to describe the action part as a custom function or a predefined function is envisioned.

In an example as a HCDAS operates with a semantic search, to enable a facility manager to determine and harness the data generated by any number of the devices in a facility. In addition to determining device data, the HCDAS may be used to configure parameters for none, some, and/or all of the devices depending on the data that has been received and processed. In one example, the connected devices may transmit their data after certain intervals and send alerts when certain events occur. After a period of time, the facility illustrated may install new air-conditioning units that manage temperature by regulating the use of associated compressors. Now, a facility manager may also want to query the information about these new air-conditioning units, utilizing a semantic search, and to shut them down, utilizing operational rules derived from a HCDAS, when they consume more energy than a specific pre-determined threshold to save energy.

Operational rules may be designed in such a manner as to fulfil the following purposes, (1) evaluate conditions related to resources and capabilities, (2) perform control of resources and capabilities when these conditions are met, (3) notify a user when a certain condition has been met, (4) provide a lifecycle to each rule that allows the rule to be installed, activated, deactivated and/or uninstalled, and/or (5) co-operation between operational rules allowing for example multiple operational rules to re-use the same action definition.

A conditional part of a rule may be designed to be very flexible. A condition may consist of the evaluation of multiple resources and capabilities. A basic condition may be defined as a condition that takes only one resource or capability into account. Therefore, the condition part of a rule may consist of the evaluation of multiple basic conditions combined by logical operators.

From this embodiment, there are generally two paths to facilitate an implementation of a semantic search, a semantic rules engine controller, or a HCDAS, to analyze, develop, and/or execute operational rules. First, is to utilize a tailored solution, where a search or operational rules are built for a specific embodiment and as new requirements arise, reconfigure a new solution. This option may not scale well and may be a roadblock to adapt to new embodiments quickly or implement new operational rules more efficiently. A second option may be to have a more flexible solution that may be implemented which does not require reconfiguring a complete solution and realizes the benefits of a semantic search, a semantic rules engine controller, or a HCDAS. In this embodiment, the potential solution may have the following characteristics: (1) expressing requirements and conditions in an explicit manner to control the devices and/or to send alerts; (2) deployment strategy of these requirements may be localized in the devices; (3) an efficient mechanism to execute these requirements programmatically; and (4) contextual query capability to gain insights about the current status of the devices and/or energy consumption, or any other desired characteristic of a system.

In addition to these requirements, the proposed solution may be suitable for embedded environments, easily integrated into any existing devices, modular in design to allow evolution of the solution, independent of device types, and/or independent of protocol or application domain constraints.

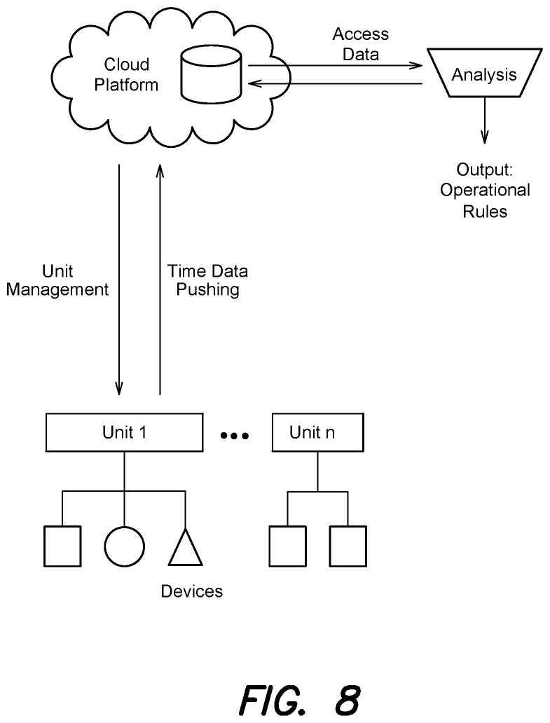

FIG. 8 illustrates extensible alternate embodiments of a HCDAS. It should be appreciated a HCDAS and associated components may be implanted with any number of technologies. Examples include, but are not limited to, JESS, JBoss Drools, Lua and/or OpenRules.

In one embodiment Lua was selected due to the following factors: (1) Lua has been developed for embedded systems; (2) Lua is open source and has a strong user base; (3) Lua syntax may be understood by non-technical users of a system; (4) Lua allows a wide range of expressions; (5) Lua has lightweight open source interpreters in many languages including Java and C thereby facilitating integration within different products.

In this embodiment a rule may be written as a Lua script which is then executed by the Lua interpreter. Both Java and C versions of rule engines were developed for different hardware platforms offering similar functionality. Supporting functions may include a list of Java or C functions to provide support for subscriptions and timers for execution of rules. An execution environment may be created by the Lua interpreter and ensures that multiple rules do not interfere with each other during their execution.

Lua also allows a rule to call a normal Java or C function whose actual implementation has been done in a Java method or C function. Additional features may be supported through these implementations and rules can simple call these functions accordingly. Further, functions may be provided by the Engine API module. It should be appreciated other appropriate programming languages may be used to reach the desired effect.

In another embodiment, a Java version of HCDAS was deployed on a commercial off-the-shelf industrial gateway device which is able to connect to variety of devices and remote cloud platforms using the Modbusl, Ethernet, Wi-Fi and/or GPRS interfaces, among others. A gateway may use Linux OS with IBM J9 as Java Virtual Machine (JVM). J9 is specific for embedded systems and has been certified for industrial usage. ProSyst2 implementation of Open Service Gateway initiative (OSGi) is a framework used over J9 to facilitate modular design of the software components running over ProSyst2. HCDAS may be implemented as one such component.

In yet another embodiment, the C version of HCDAS is implemented for a different hardware platform which is based on dual core Cortex A9 chip clocked at 900 Mhz with 1 GB RAM. It should be appreciated other hardware platforms may be used. HCDAS may also run Linux4 for embedded systems. Connectivity options include, but are not limited to, ZigBee, Ethernet, Bluetooth and/or Wi-Fi. HCDAS may be developed as a POSIX compliant library that may be imported to other client application projects.

Device and measurement identification with the semantic engine may allow referencing and detection of devices and measurements based on their metadata. Ontology may be created giving a knowledge representation of the energy management domain. This may allow the rule engine to then run queries against the ontology to identify certain devices and measurements based on their metadata. This is extremely useful as the current system may not allow easy access to a device unique identifier. Furthermore, as the topology may change due to devices being added or removed, the semantic engine may keep track of this dynamic nature, ensuring that the results of the query are up to date.

An additional benefit of the semantic engine is that an ontology model may define relationships between entities. As an example, a user may be interested in all of the devices located in a city. An ontology model may allow the semantic engine to detect none, some, and/or all of the devices even though the user has never explicitly specified that the device was in the city. This is possible due to the transitive relationship defined within the ontology model stating particular locations of particular resources.

A rule engine may interact with the semantic engine via the LuaJavaAPI function/method Rule.query. Such functionally includes, but is not limited to: (1) query the name of resources and capabilities based on their metadata such as location, (2) subscribe rules based on the metadata of the resources ensuring that rules stay relevant even when resources are added or removed. This allows the rules to be dynamic and may eliminates the need to update a rule each time a topology change occurs, (3) allow additional functionality such as computing the aggregation (e.g., avg, min, max, sum) of measurements, combining certain resources based on their metadata. Various inferences offered by the semantic engine assist utilizing these aggregations.

An example of the semantic engine syntax for each of the above cases is given below.
Search Resource usage: Power and loc:ConferenceRoom
   Returns a list of all the resources measuring power which are located in Stallman.
Subscribe Capability usage: Temperature and loc:ConferenceRoom with value>25
   Subscribes a rule whose condition is met when a capability measuring temperature in Conference Room has a value higher than 25 (The action part is omitted for clarity).
Avg variable usage: Temperature and @loc:Floor_1
   Calculates the average temperature measured by all devices located on floor 1. The @ sign indicates that inference should be used.

FIGS. 9A to 9N illustrate various exemplary embodiments of LUA implementation details of a HCDAS. It should be appreciated, multiple software packages exist to express operational rules in, which includes an integrated rule engine as well. Examples of these are, but not limited to, JESS, JBoss Drools, and OpenRules. It should be appreciated many tools may be used with similar effect. One possible tool is Lua to formulate the rules and is based on the following advantages:
Memory limitation of the embedded system necessitates a very small code base;
Interaction of the rule engines and Java version;
Non-technical users may utilize non-technical syntax for expressing rules;
Complexity of rule expressions from very basic to advanced rules;
General user familiarity with Lua syntax; and
A lightweight open source Lua to Java interpreter exists, LuaJ, which facilitating easy integration with the current OneESP software.

To integrate Lua into the existing framework, interpretation from Lua to Java is preferred. Two different open source Lua interpreters were considered: LuaJava and LuaJ. Other interpreters are available and may be utilized.

LuaJ library allows execution of Lua scripts on the Java platform as well as binding Lua functions to Java methods. This is beneficial as it allows a Lua script to call a normal Lua function whose actual implementation resides in a Java method. The rule engine utilizes this feature to implement the subscription of rules in Java even though the subscription is seen as a normal Lua function call by the user. To allow subscription and management of rules using Lua, the scripts have to conform to a specified syntax.

Particular formats allow the Lua scripts to contain operational rule descriptions as well as adding a lifecycle to the script and associated rules. Furthermore, it is possible to define certain

Lua functions as the action part to be executed when a rules condition part is met. Examples of how this is achieved includes:
A Lua script may begin by defining an empty Lua Table with the same name as the script file.
   As multiple scripts will exist, these tables may be used to store all future functions of the script allowing distinction between functions of different Lua scripts.
All function declarations within the script may be included in the Lua Table created at the beginning.
   This may be achieved by appending the script name to the start of each function.
A Lua script may declare an initialization function which is called when the script is activated on the system.
   The function name is called init and may include the desired rules to be added to the system.
A Lua script may declare a finalization function which is called when the script is removed from the system.
   A function name may be called finalize and will normally include any functionality to be executed during a script removal such as informing a monitoring center of the removal or freeing up resources.
A Lua script may declare an info function that provides human readable information on what the purpose of the script is.

Various code represents calls to functions related to rule definitions. One goal of the operational rules is to evaluate measurements from a device and control devices. From the example, the following code can now be described in terms of the definitions of resources and capabilities, for example:
Rule.subscribe
   Adds a rule to the rule engine for evaluations.
Rule.unSubscribe
   Removes a specific rule from the rule engine.
Rule.getCapabilityValue
   Returns a specific measurement capability value of a given resource.
Rule.setCapabilityValue
   Sets a specific controllable capability value for a given resource.
Rule.alarm
   Sends an alarm to RSP for monitoring purposes.

These functions allow lifecycle management of a library of rules as well as interaction with any devices and/or resources. The collection of above mentioned functions and other functions related to the rule engine is contained in what is later referred to as the LuaJavaAPI. Implementation of the rule engine is described herein which handles the operational rules subscribed via the adapted Lua scripts.

A rule engine component is illustrated in FIG. 9B and is a custom component which may be added to a hardware and/or software platform. By adding this software component, a hardware and/or software platform provides the capability to specify rules in addition to typical data logging functionality. FIG. 9A illustrates how the different bundles of the Rule Engine component fit together.

The Lua scripts containing the rules need to be deployed to the hardware and/or software platform. The Lua Script Management interface bundle is exposed to the user in three distinct manners allowing this deployment.
Lua Command line bundle exposes the interface using the standard command line/terminal of the hardware and/or software platform.
Local HMI bundle exposes the interface for remote access of a single hardware and/or software platform via a web browser.
Lua-RSP Agent bundle exposes the interface to the RSP via the RSP Agent's message handler service. This message service interacts with the Lua Remote HMI. It allows remote Lua script management for multiple hardware and/or software platform via a web browser.

The interface defined within the Lua Script Management interface bundle may be implemented within the Lua Engine bundle whose purpose is to declare an interface specifying the different actions that can be applied to a Lua script. These actions allow transitions between the different lifecycle states of the Lua script. A Lua script can be in two states (resolved, active) reachable by four different actions. The meaning of each action is as follows:
Install—The Lua script is loaded and all functions within the script are available for use.
Start—The Lua script init function is invoked and all rule subscriptions declared within the init function are now evaluated by the rule engine.
Stop—The finalize function of the Lua script is called and all rule subscriptions made by the script are removed from the rule engine.
Uninstall—The script is uninstalled and all functions declared by the script are removed from the system.

This bundle contains an interface called LuaScriptManagement interface as well as a helper class called LuaRuleStructure. The four above mentioned actions form the basis of the LuaScriptManagement interface methods. Two additional methods are added to aid with script management, the one providing information on a specific script and the other indicating the state in which all the scripts are. The LuaRuleStructure is used exclusively as the objects within the list returned by the method getListOfExistingScripts. Instances of this class contain information that is of use to display to the user via the different human machine interfaces (HMI).

Of interest is that the interface methods corresponding to the Lua script lifecycle return a Boolean indicating whether the action was successful or not. Also note that the method installLuaScript is overloaded and can take either a string or a file as an argument. The former is used by the LuaCommandline bundle and the latter by both the Local Lua HMI and Lua-RSPAgent. Lastly note that the return types of List<LuaRuleStructure> for method getListOfExistingScripts is only specified for clarity the actual implementation is in JRE1.4 (Java Runtime Environment 1.4) which does not support generics.

Lua Command line bundle exposes the LuaScriptManagement interface via the command line. The different methods of the interface are accessed by typing the following example commands:
lua.install <Lua file location>
lua.start <Lua file name>
lua.stop <Lua file name>
lua.uninstall <Lua file name>
lua.info <Lua file name>
lua.ls

The bundle contains a single class called LuaCommand which implements the interface PluggableCommands of the ProSyst OSGi framework. The code for this class is straightforward and consists of invoking the correct method of the LuaEngine interface based on the command given via the command line.

The bundle does not verify that the parameters sent via the command line are valid or not, instead this is left to the specific implementation of the LuaScriptManagement interface. The motivation for this is to centralize the validation at the LuaScriptManagement implementation. Otherwise validation would have to be done independently at each and every service that exposes the LuaScriptManagement interface.

The Lua Local HMI exposes the LuaScriptManagement interface for a single hardware and/or software platform box via a tab called Control on the existing web interface. The upload button corresponds to the install, after installation the script appears in the table containing the available rules. It can then be started and stopped by clicking on the “active” or “resolved” buttons respectively. The script is uninstalled by clicking on the rubbish bin icon next to the script. The HMI was designed such as to fit in with the existing web interface and ensure ease of use for the user.

The bundle may consist of the following classes:
LuaAdapterServlet
   Tasked with handling HTTP get and post requests from the client side and invoking the related methods of the LuaEngine interface.
LuaAdapter
   OSGi component that registers an instance of the LuaAdapterServlet class into the URI namespace on activation. This makes the servlet reachable for use.
LuaSettings
   Sets specific permission levels for the LuaAdapterServlet's different HTTP methods.
ServletConstant
   Constants used regularly within the bundle.

Furthermore, the standard style sheets (.css) of the web interface may be used. To allow for the dynamic nature of displaying the Lua scripts the Knockout java script libraries is used.

A Lua Local HMI bundle allows access to the LuaScriptManagement interface on a single hardware and/or software platform via a HMI. The need however exists to be able to access the LuaScriptManagement interfaces of multiple units remotely using a single HMI. For this purpose, a web HMI was created that sends messages to the RSP platform which in turn forwards these messages to the corresponding hardware and/or software platform. The Lua-RSP Agent bundle resides on the hardware and/or software platform and is responsible for interpreting these messages and calling the corresponding methods of the LuaScriptManagement interface.

The HMI bundle may consist of the following classes:
LuaRspMessageHandler
   Handles messages sent from RSP to the device related to Lua and invokes the relevant LuaEngine interface method.
   Extends the MessageHandler class of the RSP Agent bundle and implements the abstract handleMessage method.
LuaRspReceiver
   Responsible for registering a LuaRspMessageHandler instance as a service on the OSGi framework.

Example messages that are sent and received consist of the following:
The address of the intended device;
A list containing three Content objects, with the following fields:
   type (always application/text)
   field (indicates the type of data to follow)
   fileName—The data contains the name of the Lua script
   action—the data contains what to do with the script (install/start/stop/uninstall)
   base64—if the action is install, indicates that the data to follow is the text of the Lua script and is encoded with base 64.
   data (the actual information)

The LuaRspMessageHandler extracts the necessary information from the message and invokes the corresponding LuaScriptManagement methods. At present the LuaRspMessageHandler may not reply to RSP to indicate that the message was delivered successfully (it is asynchronous).

The Lua Engine bundle comprises of the majority of development done during the project. It firstly implements the LuaScriptManagement interface allowing the efficient management of the Lua scripts. Secondly it is responsible for the evaluation of the conditions of all rules and executing the corresponding actions. An overview of all of the packages contained in the bundle is given, followed by an in-depth description of the classes and functionality within each package.

The Lua Engine Implementation bundle is split into different Java packages separating different logical functionality from each other. As indicated by the package name, this package contains the main functionality for the bundle as well as being the entry point for other bundles wishing to use this bundle. A description of the different classes clarifies how the Lua Engine operates:
interacts with the Data Model bundle;
interacts with the RSP Agent bundle;
interprets Lua scripts; and
binds Lua functions to Java methods.

The lua.engine.main package consists of four classes:

1. LuaEngineImpl

The purpose of this class is to implement the LuaScriptManagement interface. This class is registered as a service on the OSGi platform. This allows the service registry to match the bundles requiring a LuaScriptManagement service (Lua command line, Local Lua HMI, Lua-RSP Agent) to the class.

The following takes place at bundle start up allowing the interaction between the Lua Engine component and the RSP Agent, Data Model and Semantic Engine component respectively.
The OSGi platform ensures that a instance references to the following classes are provided:
   ResourceRegistry—registry containing all of the devices connected to the hardware and/or software platform (uses the Data Model component).
   EventHelper—Sends events to RSP (uses the RSP Agent component).
   ISemanticEngine—reference to the semantic engine for device and measurement identification (uses the Semantic Engine component).
Creates a default Lua table called globals for the Lua interpreter (LuaJ). This table contains all the standard libraries and functionality associated with Lua.
Adds an instance of the LuaJavaAPI to the globals table. This allows accessing Java methods as Lua functions. This is discussed in section B below.

2. LuaJavaAPI

The goal of this class is to define methods within Java that are callable as functions from Lua. This includes the methods allowing the Lua script to add or remove rules from the rule engine called subscribe and unSubscribe.

3. Const

Contains static final objects used as constants. The reason they are used instead of the enum type is that Java version 1.4 does not support the enum type. It contains certain strings that are often used as well as the path of directories used to store Lua scripts in.

4. LuaScriptStatusChecker

A helper class responsible for keeping track of the state (resolved, active) that a Lua script is in.

When a Lua script is installed it has to adhere to a certain format as specified. This package aims at validating that these specifications are met. The package itself consists of an interface LuaScriptValidator as well as its implementation LuaScriptValidatorImpl. The two methods that are implemented and the tests they perform are:
boolean validateMandatoryFunctions(String scriptName)
   Checks that the Lua script name is not a reserved word used in the LuaJ interpreter such as require or math. This is checked as the script has the capability to override an existing Lua table contained in globals containing for example the math library of Lua.
boolean validateLuaScriptFormat(String scriptName)
   Checks that the mandatory functions init, finalize, subscribe and unsubscribe are declared in the Lua script.

This concept contemplates range checking and syntax of the operational rules. Once the script has been validated it can be installed. The next step is to subscribe all of the rules declared in the Lua script init function when the script is started.

The LuaJavaAPI can be used to subscribe rules to the rule engine. Once the rules have been added, the lua.engine.subscription package is tasked with handling these rules. The rules are of the ECA (Event Condition Action) type. This package purpose is to listen for the events, evaluate the conditions of the related rules and if the condition is met execute the action.

The overall functioning of this package is illustrated in FIG. 9C. For each Lua script a map is created with keys corresponding to the condition part of a rule. Each key is mapped to an action related to the specific condition. The LuaJavaAPI is used to add or remove rules from the maps. The package then listens for events and determines the relevant rules. After which the evaluation of the condition part of the rule is delegated to the lua.engine.parser package. If the condition is met the package executes the action by invoking either a Lua function using the LuaJ interpreter or a method specified in the LuaJavaAPI.

The Subscriptionlistener class implements the OSGi EventHandler interface allowing it to receive Events.

The condition part of the rules was designed to be very flexible, compensating for the limitation imposed by the OSGi EventHandler events. The different type of basic conditions may be stored in a separate package.

The condition part of an operational rule forms the bases for the class definitions below. The implementation of the condition part of a rule is illustrated in FIG. 7A. For each condition of a rule an instance of the Condition class is initiated. This instance contains a list of all the basic conditions, these basic conditions can be of five different types based on the different basic conditions. This allows the expression of advanced conditions that integrate the event part of a rule as well.

Examples of the different classes corresponding to a basic condition are listed below and illustrated in FIG. 9D.
Resource Capability
Resource
ResourceCapabilityChange
ResourceCapabdityIncr
ResourceCapabilityDecr

Classes mentioned in this package allows for the evaluation of a variety of conditions. The getLeftHandSideOfCondition method of each class differs and is used during the evaluation of the condition. The ability to combine an unlimited number of basic conditions via the logical operators AND and OR allows the user to specify meaningful and powerful conditions related to his or her requirements.

As described herein a complete condition consists of multiple basic conditions. The complete condition will be passed to the rule engine as a String using the LuaJavaAPI. The aim of this package is twofold:
Parse the String containing the complete condition so as to construct the different basic condition objects.
Evaluate the complete condition to see if the action part of the rule should be executed.

Parsing allows the construction of the different basic condition types. At evaluation time the values corresponding to these objects replace their corresponding part in the condition string (getLeftHandSideOfCondition method). The complete condition is now evaluated as shown in FIG. 9E. Note that based on the type of basic condition different values are returned. The Resource Capability object returns the current value of the capability while the objects corresponding to the other classes return true or false depending on whether the basic condition is satisfied or not. The arithmetic expression can then be evaluated as illustrated in FIG. 9F.

While Expr Java library was chosen to perform the parsing and evaluation of conditions, others may be chosen based on:
The small code size (22 Kbytes JAR) is ideal for an embedded system;
Open Source nature of source code; and
Clear API and well documented code allowing for modifications.

Some modifications had to be made to the Expr library. As it was mainly developed as an expression evaluator, the code was slightly modified adding the parsing functionality. This allows the extraction of the necessary data to construct our basic condition objects. It is foreseen that the parsing and expression/condition evaluation might be done differently in the future.

For example, AntlR might be used as a parser, if at some stage the condition statement evolves beyond the capabilities of the parser of the Expr library. For this reason, the interface and implementation is well separated (loose coupling). This allows the exact implementation to change in the future using a completely different technique.

The above-mentioned flexibility is achieved using the Factory Design Pattern as specified in. An interface called ConditionParserEvaluator was created with the following two methods:
boolean evaluateCondition(String condition)—which evaluates a complete condition and if the condition is met returns true.
Set constructBasicConditionsFromCondition(String completeCondition)—returns a set containing all of the basic condition objects as specified in section 4.2.4.5 relevant to the condition statement.

FIG. 9G illustrates the simplified UML diagram of the package using the factory design pattern ensuring loose coupling for the condition parsing and evaluation.

Various packages may make up the Rule Engine bundle. It explains the different logical components used to add Lua scripts as well as evaluate rules contained within the Lua scripts. What still needs explanation is how exactly a rule definition in a Lua script is subscribed to the actual rule engine implemented in Java code.

The LuaJavaAPI contains a library of designed Lua functions that are bound to Java methods and are illustrated in FIG. 9H. This API is what allows the user to interact with OSGi components on the hardware and/or software platform unit via Lua scripts.

These Java methods are all accessible through a Lua table called Rule which is added to the Lua table globals at bundle activation time. To allow a rule to be added to the rule engine the subscribe function contained within the Lua table (Rule), is invoked, which in turn invokes the corresponding Java method in the LuaJavaAPI class and adds the rule to the rule engine. The syntax for invoking the subscribe function in Lua is as follows:

Rule.subscribe(scriptName, ruleCondition, functionTable, function, arguments . . . )
String scriptName indicates to the rule engine which Lua script loaded the rule.
String ruleCondition contains the complete condition part of the rule
The arguments from argument three onwards are all related to the action part of the rule as discussed below.

The action part of the rule was designed to be a Lua function to allow more flexibility to the user. This function can either be contained in a Lua script or be part of the Lua functions mapped to Java methods of the LuaJavaAPI. Recall that each Lua script is stored in its own Lua table with the same name as the script. Hence the possibility to call any function from any Lua script by just specifying:
String functionTable, either a script name or—Rule corresponding to the LuaJavaAPI.
String function, the actual function to call.
arguments, a list of arguments to pass to the function.

The LuaJavaAPI contains a few other functions/methods as listed in table 4 below. The most important of which are:
setCapabilityValue—allows the control of a smart device making use of the Data Model component service.
sendAlarm—allows sending alarm or other events to the RSP making use of the RSP Agent component.

Rules defined in Lua scripts are added and removed from the rule engine by invoking the subscribe and unSubscribe functions respectively. Furthermore, it introduced, among others, functions allowing interaction with the Data Model and RSP Agent components. This adds control and event functionality.

The entry point to the Lua Engine bundle is effectuated by either an invocation of a method of the LuaScriptManagement interface or the occurrence of an event.

FIG. 9I illustrates the program flow when a Lua script is installed. Recall that globals is a Lua table from which the LuaJ interpreter accesses all Lua related functionality.

FIG. 9J illustrates the program flow when a Lua script is started. The final step is to invoke the init function of the script. This will execute any commands within this function. Typically, the subscription of rules will take place within this function. For this reason, the program flow after a call to the subscribe function which is illustrated in FIG. 9K.

FIG. 9L illustrates the program flow when a Lua script is stopped. It invokes the finalize function of the script. Typically, the unsubscribing of rules will take place within this function. The unSubscribe function removes the specified rule from the map created by the lua.engine.subscription package. The design is such that if the user does not specify an explicit unsubscribe of a rule, the software will implicitly remove the rule when the script is stopped. This is best practice as it does not assume that the user will do the necessary cleanup.

FIG. 9M illustrates the program flow when a Lua script is uninstalled. All the scripts functions are removed from the globals table by removing the table with the same name as the Lua script name.

The lua.engine.subscription package starts the rule evaluation once an event is detected. It iterates through all of the rules, delegating the condition evaluation to the lua.engine.parser package. If the condition is met it then executes the corresponding action part by invoking the related Lua function using the LuaJ interpreter as illustrated in FIG. 9N.

The Lua Remote HMI fulfils a similar task to the Lua Local HMI, with the difference that from the remote HMI it is possible to communicate with multiple units. To allow Lua script management, it sends messages of the format to RSP, which then forwards it to the corresponding box. The grey rules indicate the resolved rules that have not yet been activated. In addition, the HMI displays the events sent via the RSP Agent to RSPHMI contains the web front end for rule management and event monitoring. The remote HMI was built upon the REST architecture.

The query function can be used directly within a Lua script to make use of the semantic engine. However, it is also useful to have a HMI to allow ad-hoc queries as well. An example shows the HMI showing the syntax and result for a basic query. Even though the HMI part formed part of the project, its implementation is not discussed in detail in this document.

Any general-purpose computer systems used in various embodiments of this disclosure may be, for example, general-purpose computers such as those based on Intel PENTIUM-type processor, Motorola PowerPC, Sun UltraSPARC, Hewlett-Packard PA-RISC processors, or any other type of processor.

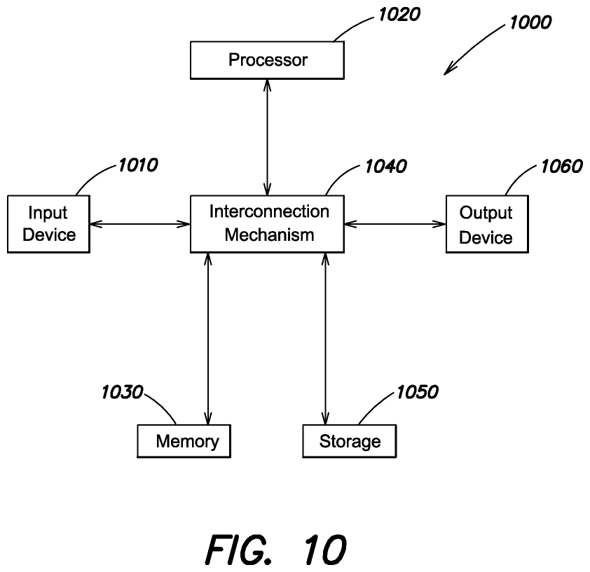

For example, various embodiments of the disclosure may be implemented as specialized software executing in a general-purpose computer system 1000 such as that shown in FIG. 10. The computer system 1000 may include a processor 1020 connected to one or more memory devices 1030, such as a disk drive, memory, or other device for storing data. Memory 1030 is typically used for storing programs and data during operation of the computer system 1000. The computer system 1000 may also include a storage system 1050 that provides additional storage capacity. Components of computer system 1000 may be coupled by an interconnection mechanism 1040, which may include one or more busses (e.g., between components that are integrated within the same machine) and/or a network (e.g., between components that reside on separate discrete machines). The interconnection mechanism 1040 enables communications (e.g., data, instructions) to be exchanged between system components of system 1000.

Computer system 1000 also includes one or more input devices 1010, for example, a keyboard, mouse, trackball, microphone, touch screen, and one or more output devices 1060, for example, a printing device, display screen, speaker. In addition, computer system 1000 may contain one or more interfaces (not shown) that connect computer system 1000 to a communication network (in addition or as an alternative to the interconnection mechanism 1040).

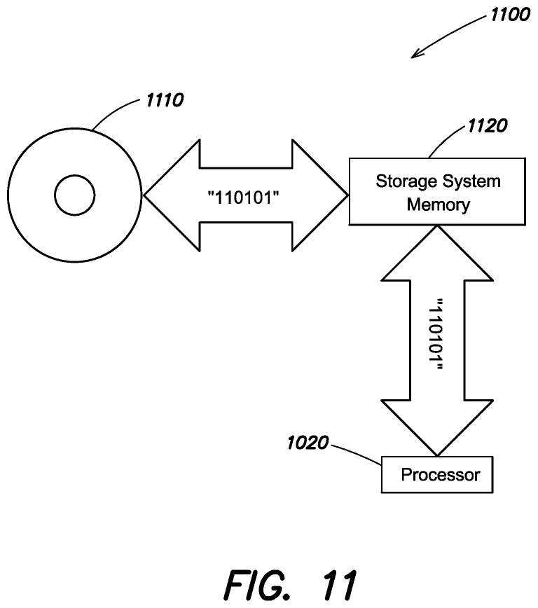

The storage system 1050, shown in greater detail in FIG. 11, typically includes a computer readable and writeable nonvolatile recording medium 1110 in which signals are stored that define a program to be executed by the processor or information stored on or in the medium 1110 to be processed by the program to perform one or more functions associated with embodiments described herein. The medium may, for example, be a disk or flash memory. Typically, in operation, the processor causes data to be read from the nonvolatile recording medium 1110 into another memory 1120 that allows for faster access to the information by the processor than does the medium 1110. This memory 1120 is typically a volatile, random access memory such as a dynamic random-access memory (DRAM) or static memory (SRAM). It may be located in storage system 1100, as shown, or in memory system 1030. The processor 1020 generally manipulates the data within the integrated circuit memory 1030, 1120 and then copies the data to the medium 1110 after processing is completed. A variety of mechanisms are known for managing data movement between the medium 1110 and the integrated circuit memory element 1030, 1120, and the disclosure is not limited thereto. The disclosure is not limited to a particular memory system 1030 or storage system 1050.

The computer system may include specially-programmed, special-purpose hardware, for example, an application-specific integrated circuit (ASIC). Aspects of the disclosure may be implemented in software, hardware or firmware, or any combination thereof. Further, such methods, acts, systems, system elements and components thereof may be implemented as part of the computer system described above or as an independent component.

Although computer system 1000 is shown by way of example as one type of computer system upon which various aspects of the disclosure may be practiced, it should be appreciated that aspects of the disclosure are not limited to being implemented on the computer system as shown in FIG. 11. Various aspects of the disclosure may be practiced on one or more computers having a different architecture or components shown in FIG. 11. Further, where functions or processes of embodiments of the disclosure are described herein (or in the claims) as being performed on a processor or controller, such description is intended to include systems that use more than one processor or controller to perform the functions.

Computer system 1000 may be a general-purpose computer system that is programmable using a high-level computer programming language. Computer system 1000 may be also implemented using specially programmed, special purpose hardware. In computer system 1000, processor 1020 is typically a commercially available processor such as the well-known Pentium class processor available from the Intel Corporation. Many other processors are available. Such a processor usually executes an operating system which may be, for example, the Windows 95, Windows 98, Windows NT, Windows 2000, Windows ME, Windows XP, Vista, Windows 7, Windows 10, or progeny operating systems available from the Microsoft Corporation, MAC OS

System X, or progeny operating system available from Apple Computer, the Solaris operating system available from Sun Microsystems, UNIX, Linux (any distribution), or progeny operating systems available from various sources. Many other operating systems may be used.

The processor and operating system together define a computer platform for which application programs in high-level programming languages are written. It should be understood that embodiments of the disclosure are not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

One or more portions of the computer system may be distributed across one or more computer systems coupled to a communications network. For example, as discussed above, a computer system that determines available power capacity may be located remotely from a system manager. These computer systems also may be general-purpose computer systems. For example, various aspects of the disclosure may be distributed among one or more computer systems configured to provide a service (e.g., servers) to one or more client computers, or to perform an overall task as part of a distributed system. For example, various aspects of the disclosure may be performed on a client-server or multi-tier system that includes components distributed among one or more server systems that perform various functions according to various embodiments of the disclosure. These components may be executable, intermediate (e.g., IL) or interpreted (e.g., Java) code which communicate over a communication network (e.g., the Internet) using a communication protocol (e.g., TCP/IP). For example, one or more database servers may be used to store device data, such as expected power draw, that is used in designing layouts associated with embodiments of the present disclosure.

It should be appreciated that the disclosure is not limited to executing on any particular system or group of systems. Also, it should be appreciated that the disclosure is not limited to any particular distributed architecture, network, or communication protocol.

Various embodiments of the present disclosure may be programmed using an object-oriented programming language, such as SmallTalk, Java, C++, Ada, or C# (C-Sharp). Other object-oriented programming languages may also be used. Alternatively, functional, scripting, and/or logical programming languages may be used, such as BASIC, ForTran, COBoL, TCL, or Lua. Various aspects of the disclosure may be implemented in a non-programmed environment (e.g., documents created in HTML, XML or other format that, when viewed in a window of a browser program render aspects of a graphical-user interface (GUI) or perform other functions). Various aspects of the disclosure may be implemented as programmed or non-programmed elements, or any combination thereof.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

1. A hybrid connected device actuation system, comprising:
at least one processor configured to:
process a hybrid actuation query that includes semantic query and rules data;
determine at least one actuatable connected device associated with a control system based on the processed hybrid actuation query data and ontological data associated with the control system;
determine an actuatable variable associated with the at least one determined connected device based on the rules data associated with the hybrid actuation query; and
execute a change in an operational state of the actuatable variable associated with the at least one determined connected device in the control system.

2. The system of claim 1, wherein the at least one processor is further configured to determine actuatable operational states associated with the determined at least one connected device by applying an ontological query component to an actuatable rules engine control module;

3. The system of claim 1, wherein the at least one processor is further configured to determine available rule actuatable variables associated with the at least one connected device by correlating appropriate hierarchical control structures in an ontological library with rule actuatable connected devices associated with the control system.

4. The system of claim 1, wherein the at least one processor is configured to determine the at least one connected device associated with a control system by correlating appropriate hierarchical control structures in an ontological library with rule actuatable connected devices associated with the control system.

5. The system of claim 1, wherein the rules data has an associated lifecycle.

6. The system of claim 1, wherein the rules data has an associated conflict mechanism.

7. The system of claim 1, wherein the rules data has an associated conditional mechanism.

8. An ontological based query and rule execution system, comprising:
at least one processor configured to:
receive a structured search query having query elements and a rule data set;
identify a set of connected elements based on the query elements;
annotate a data structure of each of the identified set of connected elements to form a queried data set;
provide the queried data set to a rule engine;
evaluate conditions related to the set of connected elements and the rule data set;
determine a command set based on the evaluated conditions of the set of connected elements; and
execute the command set on the set of connected elements.

9. The system of claim 8, wherein the at least one processor is configured to determine the command set by applying a structured search query component to a rule engine control module;

10. The system of claim 8, wherein the at least one processor is configured to determine available rule actuatable variables associated with the set of connected elements by correlating appropriate hierarchical control structures in an ontological library with rule actuatable connected devices associated with a control system.

11. The system of claim 8, wherein the at least one processor is configured to determine the set of connected elements by correlating appropriate hierarchical control structures in an ontological library with rule actuatable connected devices associated with a control system.

12. The system of claim 8, wherein the rule data set has an associated lifecycle.

13. The system of claim 8, wherein the rule data set has an associated conflict mechanism.

14. The system of claim 8, wherein the rule data set has an associated conditional mechanism.

15. A hybrid connected device actuation execution method, comprising:
processing, a hybrid actuation query that includes semantic query and rules data;
determining, at least one actuatable connected device associated with a control system based on the processed hybrid actuation query data and an ontological data associated with the control system;
determining, an actuatable variable associated with the at least one determined connected device based on the rules data associated with the hybrid actuation query; and
executing, a change in an operational state of the actuatable variable associated with the at least one determined connected device in the control system.

16. The method of claim 15, wherein determining the actuatable operational states associated with the determined at least one connected device includes applying an ontological query component to an actuatable rules engine control module;

17. The method of claim 15, wherein determining available rule actuatable variables associated with the at least one connected devices includes correlating appropriate hierarchical control structures in an ontological library with rule actuatable connected devices associated with the control system.

18. The method of claim 15, wherein determining at least one connected device associated with a control system includes correlating appropriate hierarchical control structures in an ontological library with rule actuatable connected devices associated with the control system.

19. The method of claim 15, wherein the rules data has an associated lifecycle.

20. The method of claim 15, wherein the rules data has an associated conflict mechanism.

21. The method of claim 15, wherein the rules data has an associated conditional mechanism.
